(19) United States
(12) Patent Application Publication
(10) Pub. No.: US 2012/0177011 A1
(43) Pub. Date: Jul. 12, 2012

(54) METHOD AND APPARATUS FOR SIGNALING FOR MULTI-ANTENNA TRANSMISSION WITH PRECODING

(75) Inventors: Fengjun XI, Huntington Station, NY (US); Benoit PELLETIER, Roxboro (CA); Lujing CAI, Morganville, NJ (US); Hong O. ZHANG, Manalapan, NJ (US); Joseph S. LEVY, Merrick, NY (US); Diana PANI, Montreal (CA); Yingxue K. LI, Exton, PA (US)

(73) Assignee: INTERDIGITAL PATENT HOLDINGS, INC., Wilmington, DE (US)

(21) Appl. No.: 13/341,114

(22) Filed: Dec. 30, 2011

Related U.S. Application Data
(60) Provisional application No. 61/430,756, filed on Jan. 7, 2011.
(60) Provisional application No. 61/441,770, filed on Feb. 11, 2011.
(60) Provisional application No. 61/481,070, filed on Apr. 29, 2011.
(60) Provisional application No. 61/522,454, filed on Aug. 11, 2011.

(51) Int. Cl. H04W 72/04; H04W 88/08; H04W 88/02

(52) U.S. Cl. 370/335; 370/328; 370/329

(57) ABSTRACT

A method and apparatus for signaling for multi-antenna transmission with precoding are disclosed. Precoder phase information may be signaled using bit sequences that provide a degree of error tolerance in that precoder phases having large differences are signaled using bit sequences having large Hamming distances.

This application claims the benefit of (i) U.S. (“US”) Provisional Patent Application Ser. No. (“Prov. Pat. Appln. Ser. No.”) 61/430,756, filed on 7 Jan. 2011, and entitled “A METHOD FOR MULTI-MEDIA TRANSMISSION SCHEMES WITH PRECODING” (Attorney Ref. IDC-10886US01); (ii) U.S. Prov. Pat. Appln. Ser. No. 61/441,770, filed on 11 Feb. 2011, and entitled “A METHOD FOR MULTI-ANTENNA TRANSMISSION SCHEMES WITH PRECODING” (Attorney Ref. IDC-10914US01); (iii) U.S. Prov. Pat. Appln. Ser. No. 61/481,070, filed on 29 Apr. 2011, and entitled “METHOD AND APPARATUS FOR SIGNALING FOR MULTI-ANTENNA TRANSMISSION WITH PRECODING” (Attorney Ref. IDC-11030US01); and (iv) U.S. Prov. Pat. Appln. Ser. No. 61/522,454, filed on 11 Aug. 2011, and entitled “METHOD AND APPARATUS FOR SIGNALING FOR MULTI-ANTENNA TRANSMISSION WITH PRECODING” (Attorney Ref. IDC-11108US01); each of which are incorporated herein by reference.

### BACKGROUND

Multiple antenna transmission/reception techniques with advanced signal processing algorithms may be referred to as multi-input multi-output (MIMO) technology. MIMO may include pre-coded spatial multiplexing, where multiple information streams are transmitted simultaneously. Spatial multiplexing may be augmented with beamforming or transmit diversity to increase the coverage when channel conditions become less favorable to spatial multiplexing. For channel dependent precoding, weights are typically selected to distribute the transmission into “directions” which maximizes the power at the receiver.

### SUMMARY

A method and apparatus for signaling for multi-antenna transmission with precoding are disclosed. Phase information may be signaled using symbol mappings that reduce the impact of symbol errors. In one method, a wireless transmit/receive unit (WTRU) receives a precoding indicator signal representing a sequence of signaling bits corresponding to a desired precoder phase value. The WTRU obtains the desired precoder phase value by comparing the sequence of signaling bits to a plurality of predetermined sequences of signaling bits. Pairs of predetermined sequences of signaling bits may be configured to be opposites of each other and are mapped so as to correspond to precoder phase values that differ by the largest increment, which may be set at 180 degrees. The WTRU applies a set of weighting values to its uplink signal stream transmitted over multiple antennas where the set of weighting values have a phase differential equal to the desired precoder phase value. The precoding indicator signal may be carried on a fractional channel of a wideband code-division multiple access downlink signal transmission. The sequence of signaling bits is equivalent to two information bits in length, which may be represented as two data bits if BPSK modulation is used, or four data bits if QPSK modulation is used.

Amplitude information may be signaled at a different rate than phase information for multi-in/multi-out closed-loop transmit diversity. Downlink signaling, uplink signaling, or both may be used. Power control may be implemented for non-precoded Dedicated Physical Control Channel.

### BRIEF DESCRIPTION OF THE DRAWINGS

Amore detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an example of a method of two-stage weight tuning with a fixed pattern using a combination of explicit and differential codebooks;

FIG. 3-FIG. 6 show diagrams of examples of phase and amplitude signaling;

FIG. 7 shows an example frame structure for a Fractional Dedicated Physical Channel-like channel;

FIG. 8-FIG. 13 show examples of signaling precoding weight amplitude information;

FIG. 14 shows an example of signaling the weight information on the Enhanced Dedicated Physical Control Channel with a channel coding chain;

FIG. 15 shows an example of an encoding chain of the Enhanced Dedicated Physical Control Channel including rank information;

FIG. 16 shows an example of a frame structure of a Fractional Dedicated Physical Channel;

FIG. 17-FIG. 18. show examples of communicating Transmit Power Control and uplink precoding control indication information in time division multiplexing in a slot;

FIG. 19 shows an example of a Fractional Dedicated Physical Channel slot format with uplink precoding control indication information overlapping an adjacent slot;

FIGS. 20A-B shows two methods of providing precoder weights;

FIG. 21 shows a method of transmitting one PCI symbol per signaling interval with DTX in a subframe;

FIG. 22A shows a method of transmitting PCI where the F-PCICH resources across 3 adjacent F-PCICH slots are used to transmit one PCI symbol;

FIG. 22B shows a method of transmitting PCI where one PCI symbol is transmitted per F-PCICH resource with PCI repetitions;

FIG. 23 shows one possible constellation mapping PCI transmission with QPSK constellation remapping;

FIG. 24 shows one possible constellation mapping PCI transmission without constellation remapping;

FIG. 25 shows a performance comparison in terms of the PCI error rate (or symbol error rate) where there is no remapping and where there is remapping;

FIG. 26 shows a PCI transmission across three different slots with constellation re-mapping; and

FIG. 27 shows a PCI transmission within one slot with constellation re-mapping.

### DETAILED DESCRIPTION

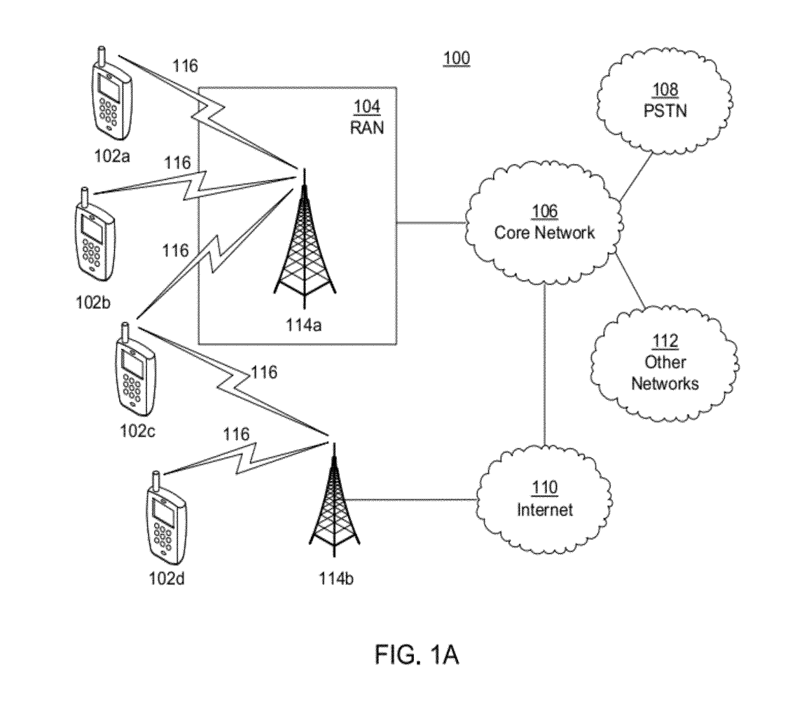

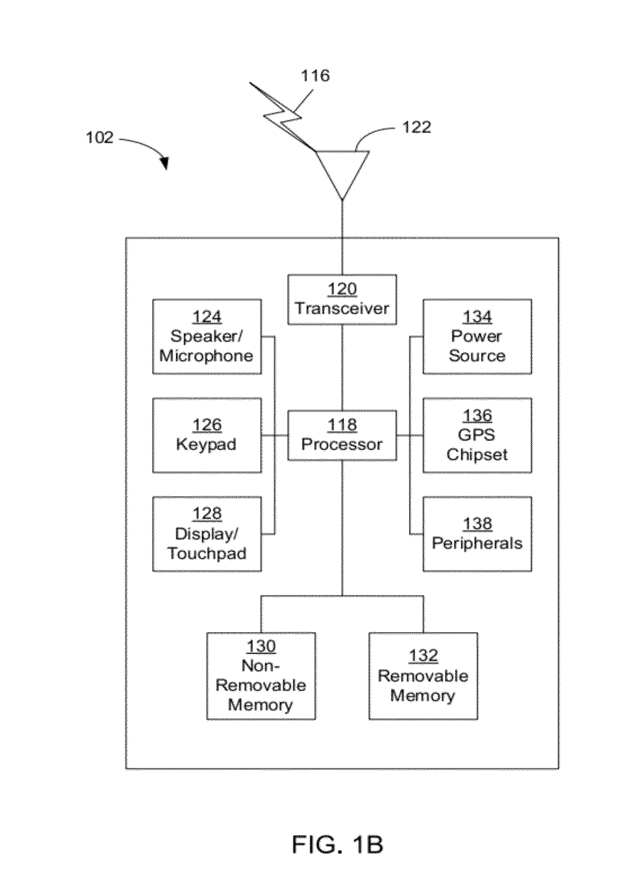

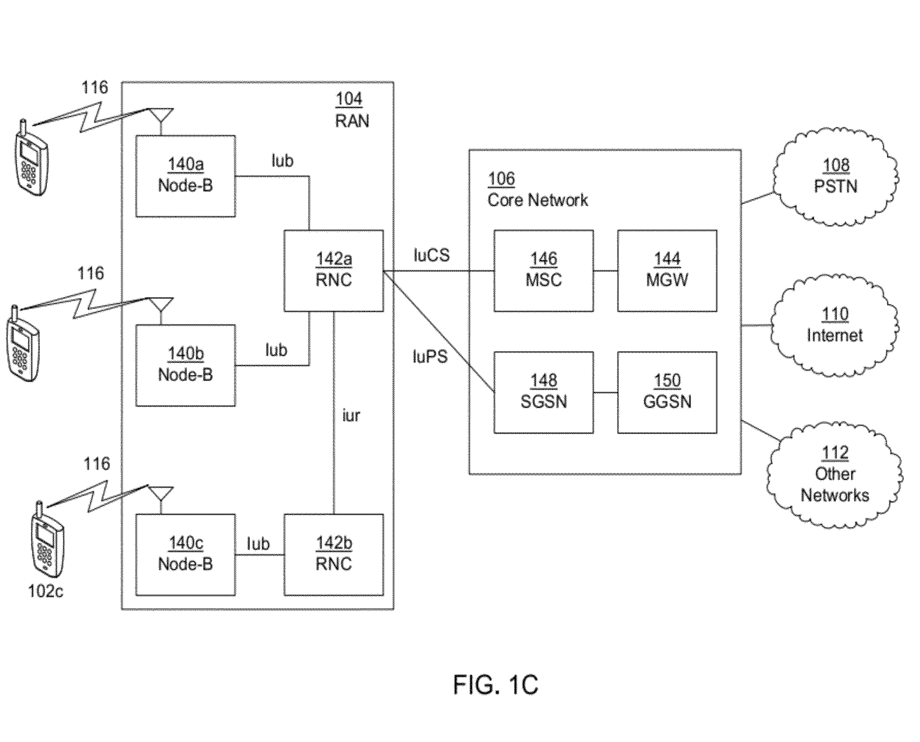

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

Although described as including two transmit antennas the methods and apparatus disclosed herein may be performed using any number of transmit antennas or other antenna technologies.

Signaling for multi-antenna transmission with precoding may include signaling precoder phase information from the base station to the WTRU using an information-to-symbol mapping that reduces the impact of symbol errors on the WTRU precoded transmissions. Further embodiments may include signaling precoder amplitude information at a different rate than phase information. Codebook-based precoding selection may include using a codebook which contains different phases or amplitudes. Additional gain may be achieved using a codebook that includes both different phases and different amplitudes. For the additional gain when signaling both phase and amplitude information, a complex valued codebook may be used containing both phase and amplitude. Two codebooks may be used including one complex-valued codebook for phase and another real-valued codebook for amplitude. Various codebook designs described herein may be used for signaling phase, amplitude, or both, in any combination.

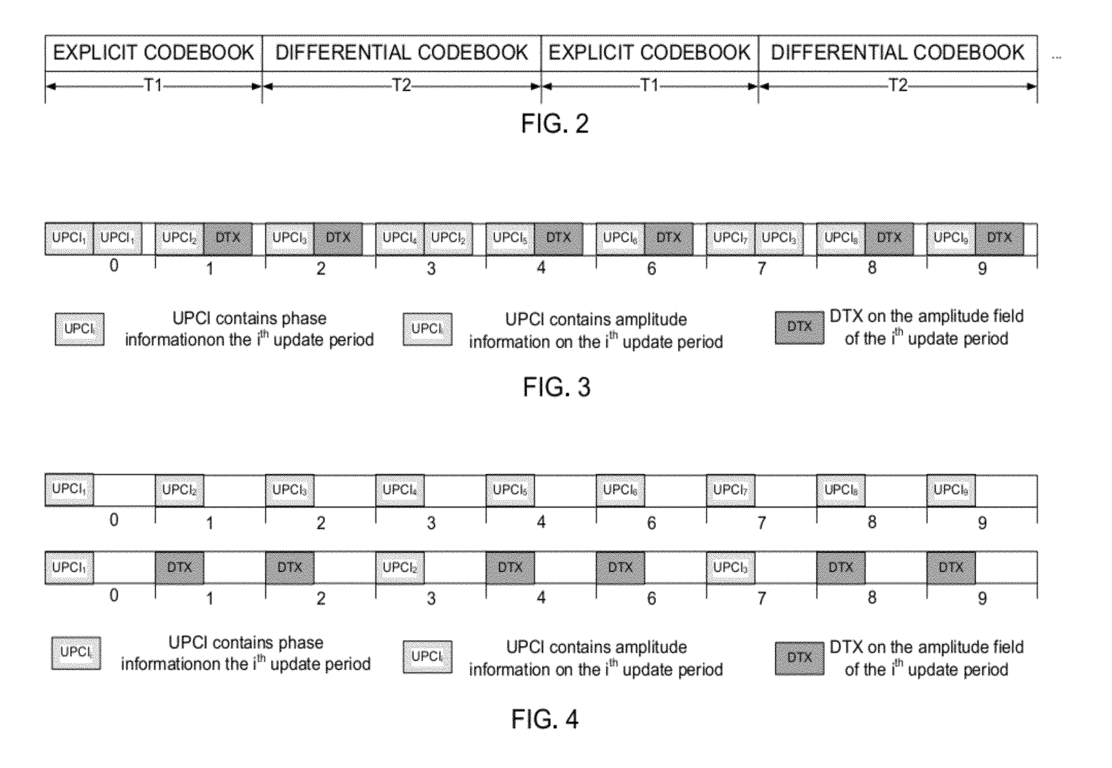

FIG. 2 shows an example of a method of one embodiment where two-stage weight tuning with a fixed pattern using a combination of explicit and differential codebooks. For a codebook-based precoding weight selection, weight information, which may contain phase, amplitude, or both, may be represented by any codebook or combination of codebooks as described herein.

Weight information may be represented using an explicit codebook where each codeword represents a specific precoding vector. The mapping between codeword and precoding vector may be predetermined. Multiple explicit codebooks may be used and may be signaled by a higher layer message, such as Radio Resource Control (RRC) message, or may be predetermined. Two explicit codebooks respectively corresponding to phase and amplitude may be used. Two explicit codebooks may be used corresponding to phase or amplitude information with different granularity, which may be determined based on a currently estimated channel fading profile, system interference level, or the like. Codebooks may be signaled by higher layers to a WTRU or to multiple WTRUs in a cell or area, such as a broadcast signal, and may be optimized based on Node-B location, environment, WTRU capability, speed, or the like.

Weight information may be represented by a differential codebook where each codeword represents an additional phase and/or amplitude offset that the WTRU may apply, and may provide higher granularity of for tracking time-varying changes of a channel. Weight information may be represented by a combination of explicit and differential codebooks.

Multi-antenna transmission with precoding may include two-stage weight tuning. The first stage (T1) may include using an explicit codebook for coarse-tuning the phase and/or amplitude of channel. The second stage (T2) may use a differential codebook for fine-tuning of the phase and/or amplitude of channel. The duration of first and second stage may be pre-defined or signaled by higher layer. For example, the duration may include a fixed pattern with a period that consists of the first stage and the second stage as shown in FIG. 2.

In an alternative embodiment, the switch between first stage and second stage may be dynamically triggered or controlled by one or more factors of the channel propagation profile, such as channel speed. An explicit codebook may be used in the first stage. A measured channel speed variation may be less than a threshold (TH1) for a given period in the first stage, and the tuning may perform the second stage, which may include using a differential code book for fine-tuning of the phase and/or amplitude of the slow varying channel. If the measured channel speed variation is larger than a second threshold (TH2) for a given period during the second stage, the tuning may perform the first stage, which may include using an explicit code book for coarse-tuning of the phase and/or amplitude of the fast varying channel.

A WTRU may use a combination of explicit codebook and differential codebooks. The WTRU may be configured with signaling parameters from a higher layer which may be used in the combination of explicit codebook and differential codebook in the multi-stage tuning embodiment. For example, tuning may include a coarse tuning period followed by a fine tuning period as shown in FIG. 2A. The tuning periods may be in a fixed pattern and the WTRU may be signaled the first (coarse) duration T1 and the second (fine) duration T2. Alternatively, tuning may include dynamic time periods used in conjunction with thresholds to determine the length of time for coarse and/or fine tuning. The WTRU may be signaled the values of the first threshold TH1 and the second threshold TH2.

A WTRU may receive preferred weight information (PWI) from an explicit codebook. The WTRU may replace the precoding weights with received values and may apply the PWI for an upcoming transmission on the next slot, sub-frame, or Transmission Time Interval (TTI). A WTRU may receive the PWI from a differential codebook and may use current precoding weights, and may apply a transformation to those, which may be performed according to the differential information received, and may apply the new weights for an upcoming transmission on the next slot, sub-frame, or TTI.

A high granularity codebook may be used to improve synchronization between WTRU and Node-B, reduce PWI or actual weight information (AWI) errors, reduce signaling overhead to carry weight information, or improve uplink (UL) performance.

Closed-loop transmit diversity (CLTD) gain may be related to codebook size and update frequency. UL performance and downlink (DL) overhead may be optimized using, for example, a codebook of between four and eight codewords. Multi-antenna transmission with precoding may include signaling uplink precoding control indication (UPCI or PCI, also referred to herein as transmit precoding indication TPI, and preferred weight information PWI) for codewords. For example, multi-antenna transmission with precoding may include signaling an 8-codewords codebook for phase (similarly, and additional codebook may be used for amplitude weights).

Using an explicit codebook including eight codewords may include using three signaling bits to explicitly signal one of eight UPCIs, as shown in Table 1. The mapping between UPCIs and explicit phases may be different than shown in Table 1. For example, the Explicit Phase may take a different value than shown in Table 1 and the granularity of 8-codeword codebook may be π/4.

TABLE 1

| UPCI for Explicit Phase | Explicit Phase |
|---|---|
| 000 | 0 |
| 001 | π/2 |
| 010 | Π |
| 011 | 3π/2 |
| 100 | π/4 |
| 101 | 3π/4 |
| 110 | 5π/4 |
| 111 | 7π/4 |

The UPCI value for each phase may be encoded so as to provide increased error protection between codewords with large phase difference. For example, larger protection to 180 degrees phase transitions may be provided for an 8 phase-only codebook. This may include mapping pairs of codewords with large relative phase difference to codeword indices with large number of differences in their bit sequence. Table 2 shows an example of a codebook including pairs of codewords with 180 degree phase difference with a 3 bit difference in UPCI encoding, which may offer more protection against signaling errors. Other mapping implementation may be implemented in a second level including other large phase differences.

TABLE 2

| UPCI for Explicit | Explicit |
|---|---|
| Phase | Phase |
| 000 | 0 |
| 111 | Π |
| 001 | π/4 |
| 110 | 5π/4 |
| 010 | π/2 |
| 101 | 3π/2 |
| 011 | 4π/4 |
| 100 | 7π/4 |

A codebook may include the [1 0] and [0 1] codewords, such as the antenna switching or AS codewords. Larger protection to transition from one AS to another may be provided. Table 3 shows an example of a 6 phase codebook including AS codewords.

TABLE 3

| UPCI for Explicit | Explicit |
|---|---|
| Phase | Phase/codeword |
| 000 | 0 |
| 111 | π |
| 001 | π/3 |
| 110 | 4π/3 |
| 010 | 2π/3 |
| 101 | 5π/3 |
| 011 | [1 0] codeword |
| 100 | [0 1] codeword |

Tables 4 and 5 show examples of codebooks including 2-bit codewords. In Table 4 the UPCI value for each phase may be encoded so as to provide increased error protection between codewords with large phase difference. Codewords with large phase difference are mapped to UPCI indices with large Hamming distance. The UPCI indices may be the same as the signaling bits or the indices may be represented by signaling bits appropriate for the constellation and modulation levels being utilized. Thus, a 00 index may be mapped to a bit sequence of 00, 00 if QPSK is be utilized to transmit an effective BPSK signaling format. This approach leads to an improved error protection since the more likely 1-bit errors would lead to smaller phase transitions.

TABLE 4

| UPCI for Explicit | Explicit |
|---|---|
| Phase | Phase/codeword |
| 00 | 0 |
| 11 | π |
| 01 | π/2 |
| 10 | 3π/2 |

TABLE 5

| UPCI for Explicit | Explicit |
|---|---|
| Phase | Phase/codeword |
| 00 | 0 |
| 11 | π |
| 01 | [1 0] codeword |
| 10 | [0 1] codeword |

Signaling overhead may be reduced. For example instead of three signaling bits, only two signaling bits may be used to signal a codeword. Reduced signaling overhead may still provide the granularity of codebook using a combination of explicit and differential codebooks. For example, the granularity of K-codeword codebook is 2π/K for K=8 and the codebook may include eight phase codewords. Granularity may be maintained using a combination of explicit and differential signaling. Table 8 shows an example including a combination phase with the granularity shown in Table 1 by adding an explicit phase from a 4-codeword explicit book using two signaling bits of UPCI for explicit phase as shown in Table 4 or 6 and a differential phase from a 3-codeword differential codebook which uses two signaling bits of UPCI for differential phase as shown in Table 7. The mapping between UPCIs and phases may differ from the mapping shown. The explicit phase may take a different value than shown in Table 6 and the granularity of the 4-codeword codebook may be π/2. The UPCI for explicit phase and UPCI for differential phase may be alternately signaled to the WTRU during each weight signaling period, such as a slot or TTI.

A WTRU may receive a UPCI for an explicit phase. The WTRU may replace the precoding weights with the received weights and may apply it for an upcoming transmission on the next slot, sub-frame, or TTI. Specifically, the WTRU may process the received UPCI indicator codeword and determine appropriate precoder weights from a codebook or lookup table stored in RAM or ROM memory, hardware register, firmware, or other memory device. The determined precoder weights to be used for the respective antennas may then be applied in the uplink transmission stream so as to alter the signal phase (and/or amplitude) of the signal transmitted by the respective antennas.

The WTRU may receive a UPCI for Differential Phase and may add the received differential phase to the current phase, and may apply the resulting combining phase, for example Combining Phase=Explicit Phase+Differential Phase, for an upcoming transmission on the next slot, sub-frame, or TTI.

TABLE 6

| UPCI for Explicit Phase | Explicit Phase |
|---|---|
| 00 | 0 |
| 01 | π/2 |
| 10 | π |
| 11 | 3π/2 |

TABLE 7

| UPCI for Differential Phase | Differential Phase |
|---|---|
| 00 | π/4 |
| 11 | −π/4 |
| 01 | 0 |
| 10 | Unused (Reserved) |

TABLE 8

| UPCI | | UPCI value | | Combining Phase |
|---|---|---|---|---|
| for | | for | | (Combining |
| Explicit | | Differential | | Phase = |
| Phase | Explicit | Phase | Differential | Explicit Phase + |
| (binary) | Phase | (binary) | Phase | Differential Phase) |
| 00 | 0 | 00 | π/4 | π/4 |
| | | 11 | −π/4 | −π/4 or 7π/4 |
| | | 01 | 0 | 0 |
| 01 | π/2 | 00 | π/4 | 3π/4 |
| | | 11 | −π/4 | π/4 |
| | | 01 | 0 | π/2 |
| 10 | π | 00 | π/4 | 5π/4 |
| | | 11 | −π/4 | 3π/4 |
| | | 01 | 0 | π |
| 11 | 3π/2 | 00 | π/4 | 7π/4 |
| | | 11 | −π/4 | 5π/4 |
| | | 01 | 0 | 3π/2 |

Differential codebook signaling may include less regularly explicit codebook signaling. This may reduce the number of signaling messages sent and may reduce the signaling overhead. The explicit codeword may be signaled via a DL channel, for example using a High-Speed Shared Control Channel (HS-SCCH) order, an E-DCH Absolute Grant Channel (E-AGCH), a Fractional Dedicated Physical Channel (F-DPCH), and may include signaling a number of signaling bits for an explicit codebook, such as 3 bits for 8-codeword codebook or 2 bits for 4-codeword codebooks. And in embodiments where a differential codebook is used, the explicit codebook signaling bits may be sent less frequently than for the differential code book. For example, explicit signaling may be signaled once per radio frame or once per several radio frames. During the period between explicit codeword signaling, the differential codeword may be signaled. The differential codebook may be simpler than the explicit codebook and may use fewer signaling bits (e.g., 1 bit shown in Table 9). The differential codeword may be signaled on a DL channel which may support a low signaling requirement (e.g. 1 bit), for example the F-DPCH. In relation to the resolution and frequency of fine-tuning of phases, a phase A may be equal to (2π/K)/L, where K is the explicit codebook size, and L may be a pre-defined or signaled value, or L may be related to the explicit codeword update period in terms of the unit of differential codewords update period. Similarly, the WTRU may determine the phase for the upcoming transmission. The Node-B may use explicit codebook signaling independent of the differential codebook signaling. The Node-B may resynchronize the WTRU/Node-B codewords whenever the Node-B has reason to believe the WTRU/Node-B codewords are not synchronized or to do so periodically for synchronization.

The PCI may be received incorrectly and may include a phase jump over n. The WTRU may point the beam in the opposite of the desired direction and may reduce the receive energy at Node-B, instead of increasing it, as desired. For the reliability of Node-B and WTRU weight synchronization, a differential phase Δ may be selected less than the granularity of the explicit codebook used.

TABLE 9

| UPCI for Differential Phase | Differential Phase |
|---|---|
| 0 | +Δ |
| 1 | −Δ |

The signaling bits that signal PCI to WTRU may be carried on a DL channel, such as E-DCH HARQ Acknowledgement Indicator Channel (E-HIGH), E-DCH Relative Grant Channel (E-RGCH), E-AGCH, HS-SCCH, HS-SCCH order and F-DPCH. Signaling AWI from WTRU may be carried on a UL channel, such as Dedicated Physical Control Channel (DPCCH) or enhanced-DPCCH (E-DPCCH).

Phase and amplitude weight information may be updated at a rate (M), which may be a pre-defined value, for example, one slot, one TTI (three slots), or one radio frame (ten slots). The rate M may be determined based on the channel speed (or coherence time). A higher channel speed may be used with a smaller M value. Similarly, channels with a smaller coherence time may use a smaller M value. For example, when the channel is very slow, such as PA0.1, M may be 30 slots or less, when the channel speed is slow, such as PA3, M may be 10 slots or less, when the channel speed is high, such as VA30, M may be less than three slots, and when the channel speed is extreme high, such as VA120 or higher, M may be reduced to zero and the transmit diversity may be disabled.

Phase and amplitude weight information may be updated at a different rate. This may be used in two code-book solution that uses two codebooks respectively containing different phases and amplitude, phase and amplitude may be updated at the same or different rate. In some embodiments, the codebooks are phase only codebooks, with the magnitudes being constant, and possibly unit magnitude weights.

The phase may be updated N times faster than amplitude to achieve a gain (e.g. 0.5 dB) in transmission power reduction by introducing amplitude into the codebook, where N>1.

N may be pre-defined value (e.g. in the specification) or signaled via RRC message by the Universal Terrestrial Radio Access Network (UTRAN). For example, phase may be updated per slot while amplitude may be updated every N slots. When N=3, amplitude is updated every TTI.

N may depend on the channel propagation file, such as speed, relative delay and relative mean power. For example, N may be determined based on the estimated speed at a Node-B. A higher speed may indicate a lower N value. For example, the Node-B may estimate the channel speed over a period, such as per slot, per TTI, or per radio frame, based on the received pilot channel DPCCH or other channel with known training sequence, and may determine N based the estimated channel speed. For example, where speed V<=3 km/h, then N=6, else if 3 km/h<V<=30 km/h, N=3, else N=1. A Node-B may update and signal a WTRU the phase weight information at N times faster than amplitude weight information for a pre-defined period or until a new N value is estimated.

N may be pre-defined value or signaled via an RRC message from the UTRAN, which may be used unless the channel speed estimation is so different from the previous one that the pre-defined or signaled N value may be accordingly adjusted. The Node-B may estimate the channel speed and determine the N value. If a different N value is derived, then the Node-B may signal it to the RNC such that the RNC may reconfigure it via an RRC message.

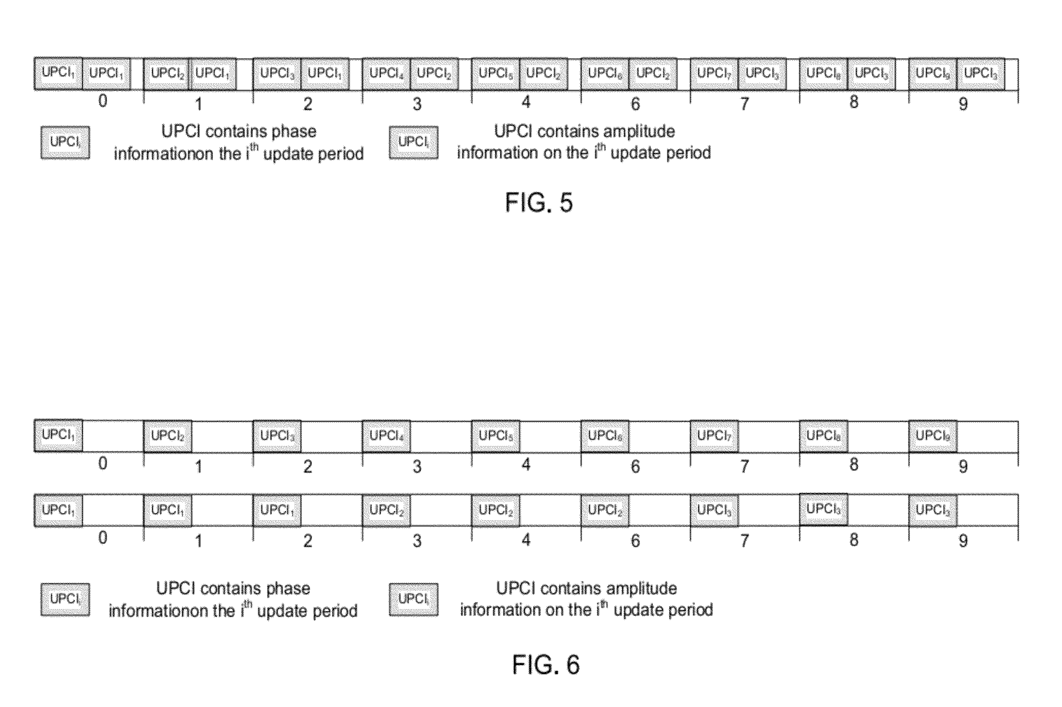

FIGS. 3-6 show diagrams of examples of phase and amplitude signaling. When signaling phase faster than amplitude, for the duration (e.g. slots or TTI) when the amplitude is not updated, the corresponding field carrying amplitude weight may be discontinuously transmitted (DTXed) or may repeat the latest amplitude weight. FIG. 3 and FIG. 4 show examples of a DTXed method including reduced signaling overhead and interference to data transmission. FIG. 5 and FIG. 6 show an example of a repeated method including reduced transmission power variation at Node-B when the WTRU may not select the weight or at the WTRU when the WTRU may not select the weight.

Phase and amplitude weight information may be carried on one channel as shown in FIG. 3 and FIG. 5. For example, a different field of each slot of F-DPCH in DL may be used. Phase and amplitude weight information may be respectively carried on two channels as shown in FIG. 4 and FIG. 6. For example, the same fields of two F-DPCHs in DL may be used.

One or two channels used may be one or any combination of DL channels such as F-DPCH, HS-SCCH, HS-SCCH order, E-AGCH and E-HICH for Node-B to signal the preferred weight information, PWI, or UL channels such as DPCCH and E-DPCCH for the WTRU to signal the actual weight information (AWI).

Although described in terms of updating phase more rapidly than amplitude, amplitude may similarly be updated more rapidly than phase.

Phase and amplitude weight information may be implicitly updated at different rate by using different number of code words for phase and amplitude weight information in the codebook. For example, the number of code words for phase information may be eight (8) while the number of code words for amplitude information may be four, statistically, the ratio of update rates between phase and amplitude weight information may be two.

The granularity of codebooks for phase and/or amplitude, such as the number of code words used to represent the phase or amplitude, may be related to the number of signaling bits to represent phase and/or amplitude weight information.

Same size for amplitude and phase codebooks may include using a number of signaling bits and/or a pattern may be used for phase and amplitude weight information. For example, every N time slots, PCIs on phase and amplitude may be simultaneously signaled by the Node-B, or AWIs on phase and amplitude may be simultaneously signaled by the WTRU.

Different sizes of amplitude and phase codebooks may be used, and a different number of signaling bits or patterns for phase and amplitude may be used. For example, to increase the accuracy of phase information, smaller sizes may be used for amplitude and bigger sizes for phase.

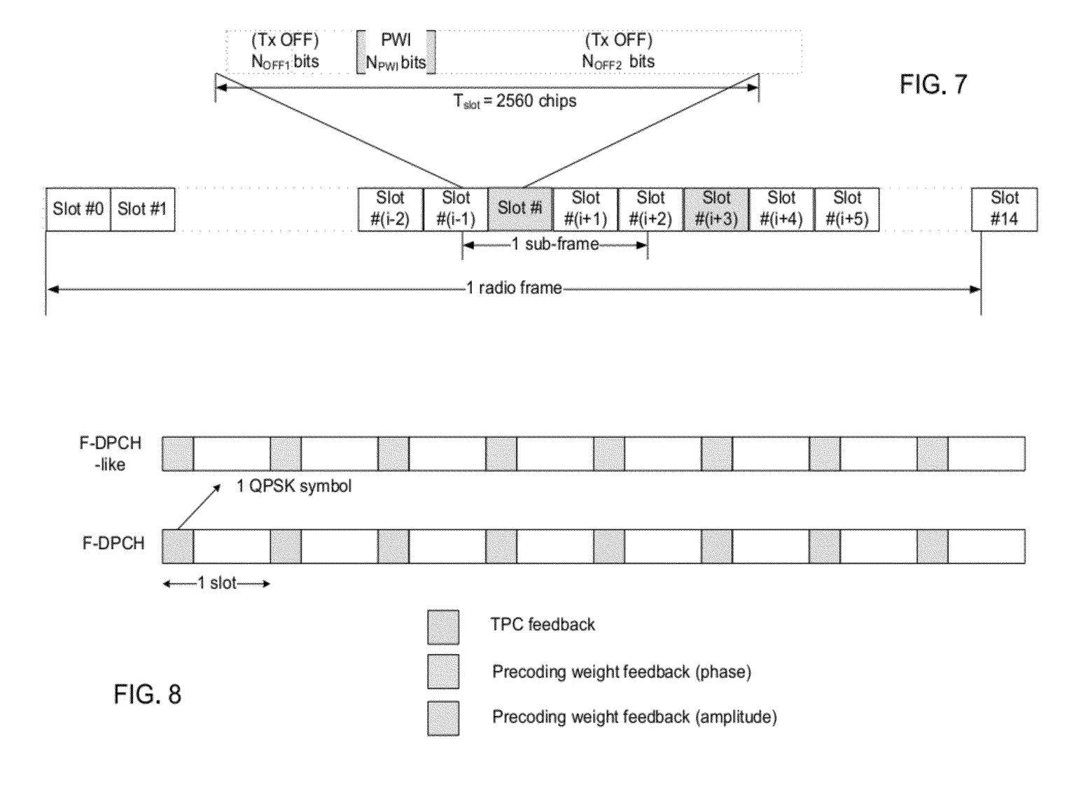

A downlink physical channel which has a format similar to an F-DPCH and uses a different channelization code may be used for Node-B to signal PCI, and may be referred to as F-DPCH-like. An example frame structure for a F-DPCH-like channel and its fields are shown in FIG. 7 and Table 10, respectively. Using an F-DPCH-like channel may not affect downlink synchronization and may be independent of the configuration of DPDCH. Signaling phase and/or amplitude may include using an F-DPCH-like channel.

TABLE 10

| | | Channel | | | | | |
|---|---|---|---|---|---|---|---|
| Slot | Channel | Symbol | | | | | |
| Format | Bit Rate | Rate | | Bits/ | NOFF1 | NPCI | NOFF2 |
| #i | (kbps) | (ksps) | SF | Slot | Bits/Slot | Bits/Slot | Bits/Slot |
| 0 | 3 | 1.5 | 256 | 20 | 2 | 0 | 16 |
| 1 | 3 | 1.5 | 256 | 20 | 4 | 0 | 14 |
| 2 | 3 | 1.5 | 256 | 20 | 6 | 0 | 12 |
| 3 | 3 | 1.5 | 256 | 20 | 8 | 0 | 10 |
| 4 | 3 | 1.5 | 256 | 20 | 10 | 0 | 8 |
| 5 | 3 | 1.5 | 256 | 20 | 12 | 0 | 6 |
| 6 | 3 | 1.5 | 256 | 20 | 14 | 0 | 4 |
| 7 | 3 | 1.5 | 256 | 20 | 16 | 0 | 2 |
| 8 | 3 | 1.5 | 256 | 20 | 18 | 0 | 0 |
| 9 | 3 | 1.5 | 256 | 20 | 0 | 0 | 18 |

Amplitude information may change more slowly than phase information, and the quantization level for amplitude may be lower than the phase. Efficient use of downlink signaling resources may include signaling phase information via a F-DPCH-like channel, and the amplitude information may be signaled via an existing F-DPCH or downlink DPCCH channel. If DPDCH is not configured, amplitude information may be signaled by overriding all or part of the Transmit Power Control (TPC) fields of some F-DPCH slots. For example, the TPC command and PCI amplitude information may be transmitted using time-multiplexing, and PCI amplitude information may be transmitted at a lower rate than TPC command. Similarly, if DPDCH is configured, the amplitude information may be signaled by overriding all or part of a TPC field or part of a pilot field of one or more DPCCH slots. The TPC bit and the amplitude bit may be combined into one QPSK symbol, and their quality may be guaranteed by boosting F-DPCH or DPCCH transmit power. FIGS. 8-13 show examples including 2-bit phase information and 1-bit amplitude information, although the methods and apparatus disclosed herein may be used with other phase and amplitude information.

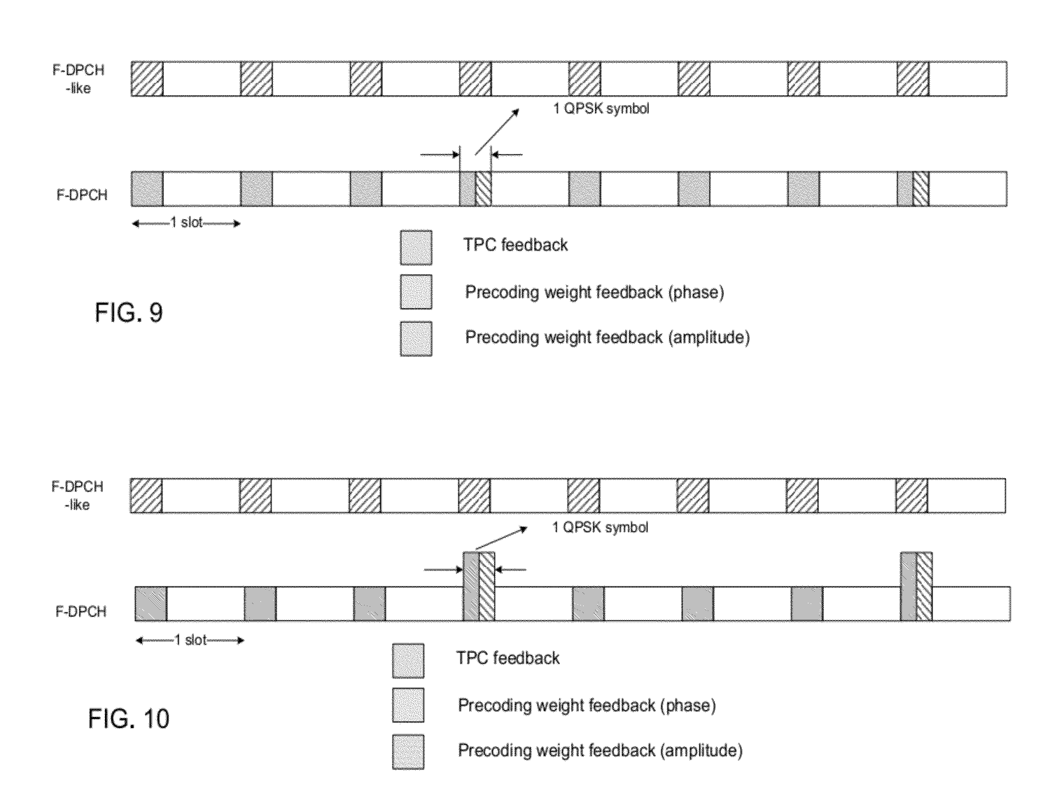

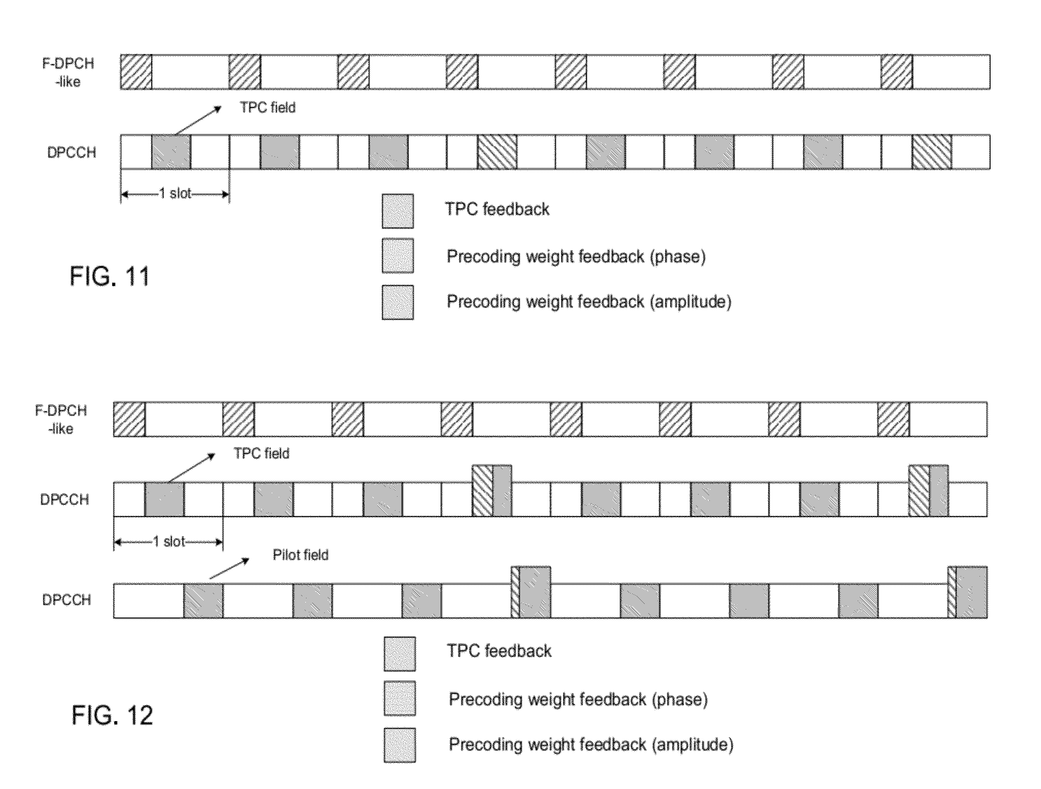

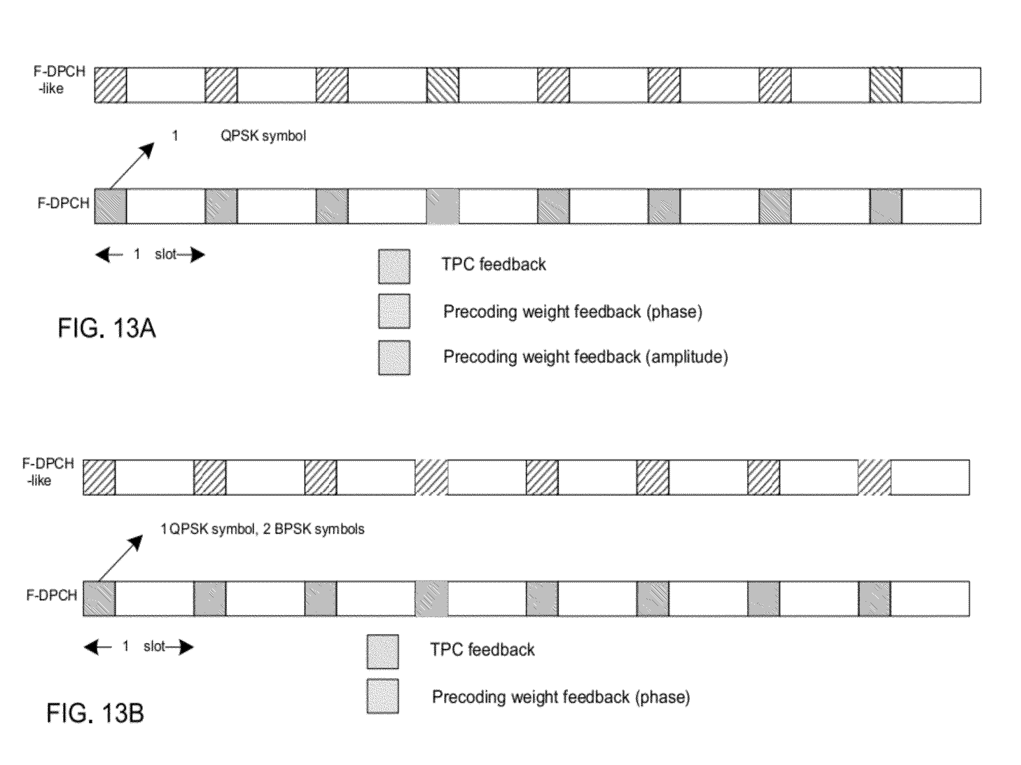

FIG. 8 shows an example of a method of signaling precoding weight amplitude information using F-DPCH wherein the amplitude information may override a TPC field. FIG. 9 shows an example of a method of signaling precoding weight amplitude information using F-DPCH wherein the amplitude information may override half a TPC field. FIG. 10 shows an example of a method of signaling precoding weight amplitude information using F-DPCH wherein the amplitude information may override half a TPC field with power boosting on the overridden TPC field. FIG. 11 shows an example of a method of signaling precoding weight amplitude information using DPDCH wherein the amplitude information may override a TPC field. FIG. 12 shows an example of a method of signaling precoding weight amplitude information using DPDCH wherein the amplitude information may override a partial TPC field or a Pilot field with power boosting on the overridden TPC or Pilot field. FIG. 13A shows an example of a method of signaling precoding weight amplitude information using an F-DPCH-like channel wherein the amplitude information may override a phase component periodically. The method shown in FIG. 13A is similar to the method shown in FIG. 2. A slower rate may be applied to an amplitude component and may be transmitted on a channel used for transmitting the phase component. FIG. 13B shows an example of a method of signaling precoding weight phase information using a F-DPCH-like channel.

The UPCI mapping tables for the phase may be used for the phase component. The amplitude component may use a mapping table that also provides protection against large amplitude variations in case of signaling errors. Table 11 shows an example of a mapping including signaling for a 1 bit amplitude selection using an F-DPCH like structure, such as a QPSK signal. That is, the single information bit may be mapped to a signaling bit sequence appropriate for a QPSK modulation scheme, where the resulting QPSK modulated signal will take on one of two phase values as in bi-phase shift keying (BPSK).

TABLE 11

| Signaling | Resulting |
|---|---|
| bits | amplitude |
| 11 | A1 |
| 00 | A2 |

A1 and A2 may indicate amplitude configurations that may be applied at the WTRU for both antennas. For example, the A1 configuration may correspond to a 75%-25% power split between the 1st and 2nd antenna and the A2 configuration may correspond to a 25%-75% power split.

A 2-bit amplitude selection may include using similar error protection. Large changes in amplitude may be protected with a larger number of different bits in the encoding. Table 12 shows an example encoding wherein the largest differences in amplitude are between amplitudes A1 and A4, and amplitudes A2 and A3, respectively.

TABLE 12

| Signaling | Resulting |
|---|---|
| bits | amplitude |
| 00 | A1 |
| 11 | A4 |
| 10 | A2 |
| 01 | A3 |

For example A1 and A4 may correspond to a 80%-20% and a 20%-80% power split between the two antennas, respectively. A2 and A3 may correspond to a 60%-40% and a 40%-60% power split between the two antennas, respectively. Similarly A1 and A4 may correspond to a 100%-0% and a 0%-100% power split between the two antennas, respectively and A2 and A3 may correspond to a 75%-25% and 25%-75% power split between the two antennas respectively.

Weight information may be signaled from a WTRU via DPCCH. This may include explicitly signaling the weight information on the DPCCH. The UE/WTRU may signal the actual pre-coding weights information for the uplink on the DPCCH channel. A DPCCH slot format may be used to carry the AWI. Table 13 shows an example of DPCCH fields including two slot formats (5 and 6) to support transmission of 2 AWI bits.

TABLE 13

| | | Channel | | | | | | | | | |
|---|---|---|---|---|---|---|---|---|---|---|---|
| Slot | Channel | Symbol | | | | | | | | | Transmitted |
| Format | Bit Rate | Rate | | Bits/ | Bits/ | | | | | | slots per |
| #i | (kbps) | (ksps) | SF | Frame | Slot | Nₚᵢₗₒₜ | N_{TPC} | N_{TFCI} | N_{FBI} | N_{AWI} | radio frame |
| 0 | 15 | 15 | 256 | 150 | 10 | 6 | 2 | 2 | 0 | 0 | 15 |
| 0A | 15 | 15 | 256 | 150 | 10 | 5 | 2 | 3 | 0 | 0 | 10-14 |
| 0B | 15 | 15 | 256 | 150 | 10 | 4 | 2 | 4 | 0 | 0 | 8-9 |
| 1 | 15 | 15 | 256 | 150 | 10 | 8 | 2 | 0 | 0 | 0 | 8-15 |
| 2 | 15 | 15 | 256 | 150 | 10 | 5 | 2 | 2 | 1 | 0 | 15 |
| 2A | 15 | 15 | 256 | 150 | 10 | 4 | 2 | 3 | 1 | 0 | 10-14 |
| 2B | 15 | 15 | 256 | 150 | 10 | 3 | 2 | 4 | 1 | 0 | 8-9 |
| 3 | 15 | 15 | 256 | 150 | 10 | 7 | 2 | 0 | 1 | 0 | 8-15 |
| 4 | 15 | 15 | 256 | 150 | 10 | 6 | 4 | 0 | 0 | 0 | 8-15 |
| 5 | 15 | 15 | 256 | 150 | 10 | 6 | 2 | 0 | 0 | 2 | 8-15 |
| 6 | 15 | 15 | 256 | 150 | 10 | 4 | 2 | 2 | 0 | 2 | 8-15 |

Another slot format may be used by re-using a field to carry AWI. For example, referring to Table 13, slot format 0 may be used, and the TFCI field may be re-used to signal the weight information. The use of this field may be implicit based on WTRU configuration. For example, the WTRU may be configured without an uplink DCH and with uplink closed loop transmit diversity, and the WTRU may be configured with DPCCH slot format 0, and the TFCI field bits may implicitly be used to carry the AWI.

The TPC field may be used to carry the AWI. The AWI may replace the TPC periodically. The period may be configured by the network.

The DPCCH slot format may change periodically to allow transmission of the AWI in addition to the other fields. For example, the WTRU may be configured by the network such that every N_{format-change} slots the WTRU transmits using an alternate (different) slot format which carries the AWI. Referring to Table 13, the WTRU may be configured to transmit using slot format 0 and may use format 6 every N_{format-change} slots as an alternate format. Various combinations of slot formats may be used. The WTRU may apply a temporary power offset on the DPCCH when transmitting with the alternate slot format. This offset may compensate for potential reduction of reliability on the reduced size field. For example, slot format 6 may be used as an alternative to slot format 0 and the length of the pilot field may be reduced by 33%. The power of the DPCCH, the pilot field may be increased to reduce the impact to the channel estimate.

Slot format 5 may be used as an alternative to slot format 4 and the length of the TPC field may be reduced by 50%. The power of the DPCCH may be increased to lower the impact on the TPC error rate.

In the case of the current weight information being signaled by the Node-B to the WTRU, the WTRU may implicitly signal the weights by toggling a new weights indicator bit (or bits) on the DPCCH, as it may tell the Node-B that new weights of the PCI have been received and applied. The Node-B may assume the PCI weights sent have been received and applied. If the bit(s) does not toggle, the Node-B may assume that the previous weights are applied and the signaling data sent by the Node-B was not received properly. In some cases when the new weights indicator bit(s) does not toggle and the Node-B did send a new PCI the Node-B may resend the PCI or the current PCI. For pre-coded DPCCH, the NobeB may blind detect using the old PCI and new PCI, checking the new weights indicator bit(s) to determine which version is valid.

The weight information may be signaled from WTRU via the E-DPCCH. As the E-DPCCH may be associated and sent with the E-DPDCH, signaling the weight information which may be used for data demodulation may use one or any combination of the following. One scenario may comprise implicitly signaling the weight information by blind decoding of the E-DPCCH for example, as the E-DPCCH is applied the same precoding weight as the E-DPDCH at the WTRU, assuming the applied precoding weight is selected from the precoding weight set with a limited number. For example, there are four precoding weight selections, then the Node-B uses blind decoding of the E-DPCCH by trying the configured pre-coding weight selections to find out which precoding weight is used at WTRU. The weight information may be explicitly signaled on the E-DPCCH.

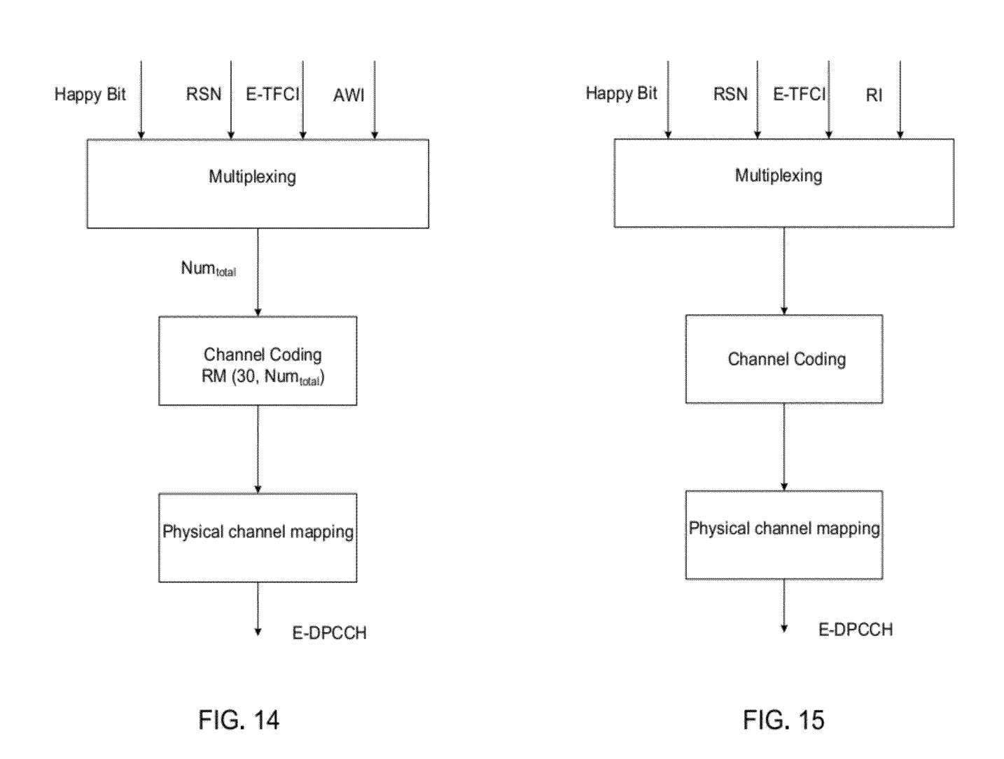

FIG. 14 shows an example of signaling the weight information on the E-DPCCH with a channel coding chain. Depending on the number of AWI to be signaled, NumAWI, a new (30, Num_total) Reed Muller (RM) code may be designed so that the NumAWI bits weight information may be encoded with NumRSN bits Retransmission Sequence Number (RSN), NumE-TFCI bits E-DCH Transport Format Combination Identifier (E-TFCI), and NumhappyBit bits Happy bit. Where, Numtotal=NumhappyBit+NumRSN+NumE-TFCI+NumAWI. For example, NumRSN=2, NumE-TFCI=7, NumhappyBit=1 or 0. Weight information may be implicitly signaled via the E-DPCCH by toggling weights bit(s), to implicitly signal weight information via the DPCCH.

Although the Node-B may indicate to the WTRU that the channel may support a rank 2 transmission, the WTRU may be given the flexibility to have the final decision on whether the next transmission may be single stream or dual stream transmission. This way, additional overhead used by rank 2 transmission over rank 1 transmission may be saved. The WTRU may indicate to the Node-B the rank information of the associated E-DCH transmission.

One embodiment may comprise a 1-bit rank information signaled via the E-DPCCH channel associated with the primary E-DCH or E-DPDCH stream. For MIMO capable UL WTRUs, a subset of legacy E-TFC may be supported so that the unused bit in E-TFCI field may be used to signal rank information. Alternately, a new (30,11) Reed Muller code may be used so that the 1-bit rank information may be encoded with 2-bit RSN, 7-bit E-TFCI, and 1-bit Happy bit. The encoding chain of the E-DPCCH including rank information is shown in FIG. 15.

Explicit rank information (RI) information may not be signaled in the uplink. The Node-B may detect the rank information blindly. For example, the Node-B may measure the received powers of the E-DPCCHs associated with the primary E-DCH or E-DPDCH stream and secondary E-DCH or E-DPDCH stream, respectively. If the ratio of the two measured powers is higher or lower than a threshold, rank-1 transmission may be determined.

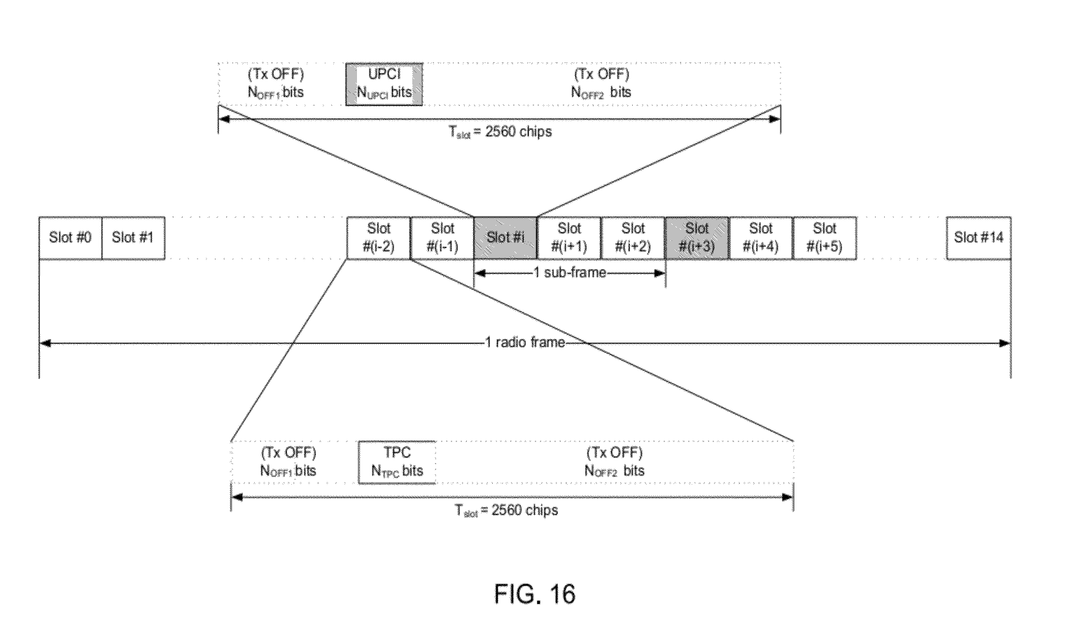

Weight information may be signaled from Node-B to the WTRU on the DL. Precoding weight information (e.g. UPCI) may be signaled on the F-DPCH with transmit power control (TPC) commands using timing division multiplexing (TDM). FIG. 16 shows one example of the frame structure of F-DPCH, where UPCI and (TPC) commands are signaled in a fixed TDM pattern. For example, UPCI is signaled every sub-frame (TTI) and TPC commands are signaled on the slots between two slots used for UPCI: specifically, for the ith Slot, if i mod 3=0, then transmitting UPCI, else transmit TPC commands. Depending on the codebook size, other formats which carry UPCI introduced in Table 14 may be used. The mapping between index of slot format and definition of F-DPCH field for UPCI may take a different form than Table 14.

TPC commands may not be signaled every slot with new F-DPCCH structure consisting of both TPC and PWI: for the UL DPCCH slot corresponding to the slot carrying UPCI may not adjust DPCCH transmission power but maintain the same power level as previous slot corresponding to the slot of F-DPCH carrying TPC command.

DL power control operation may be modified. Legacy target SIR with frame structure of F-DPCH carrying TPC commands every slot may be updated based on TPC block error rate (BER) by the open loop power control (OLPC), the target signal-to-interference ratio (SIR) with new F-DPCCH structure consisting both TPC and PWI may be estimated based on TPC BER or based on the error rate of both TPC and PWI for DLPC.

TABLE 14

| Slot | Channel | Channel | | | | | | |
|---|---|---|---|---|---|---|---|---|
| Format | Bit Rate | Symbol Rate | | | NOFF1 | NTPC | NUPCI | NOFF2 |
| #i | (kbps) | (ksps) | SF | Bits/Slot | Bits/Slot | Bits/Slot | Bits/Slot | Bits/Slot |
| 0 | 3 | 1.5 | 256 | 20 | 2 | 2 | 0 | 16 |
| 0A | 3 | 1.5 | 256 | 20 | 2 | 0 | 2 | 16 |
| 1 | 3 | 1.5 | 256 | 20 | 4 | 2 | 0 | 14 |
| 1A | 3 | 1.5 | 256 | 20 | 4 | 0 | 2 | 14 |
| 2 | 3 | 1.5 | 256 | 20 | 6 | 2 | 0 | 12 |
| 2A | 3 | 1.5 | 256 | 20 | 6 | 0 | 2 | 12 |
| 3 | 3 | 1.5 | 256 | 20 | 8 | 2 | 0 | 10 |
| 3A | 3 | 1.5 | 256 | 20 | 8 | 0 | 2 | 10 |
| 4 | 3 | 1.5 | 256 | 20 | 10 | 2 | 0 | 8 |
| 4A | 3 | 1.5 | 256 | 20 | 10 | 0 | 2 | 8 |
| 5 | 3 | 1.5 | 256 | 20 | 12 | 2 | 0 | 6 |
| 5A | 3 | 1.5 | 256 | 20 | 12 | 0 | 2 | 6 |
| 6 | 3 | 1.5 | 256 | 20 | 14 | 2 | 0 | 4 |
| 6A | 3 | 1.5 | 256 | 20 | 14 | 0 | 2 | 4 |
| 7 | 3 | 1.5 | 256 | 20 | 16 | 2 | 0 | 2 |
| 7A | 3 | 1.5 | 256 | 20 | 16 | 0 | 2 | 2 |
| 8 | 3 | 1.5 | 256 | 20 | 18 | 2 | 0 | 0 |
| 8A | 3 | 1.5 | 256 | 20 | 18 | 0 | 2 | 0 |
| 9 | 3 | 1.5 | 256 | 20 | 0 | 2 | 0 | 18 |
| 9A | 3 | 1.5 | 256 | 20 | 0 | 0 | 2 | 18 |
| 10 | 3 | 1.5 | 256 | 20 | 2 | 0 | 1 | 17 |
| 11 | 3 | 1.5 | 256 | 20 | 2 | 0 | 3 | 16 |
| 12 | | 1.5 | 256 | 20 | 2 | 0 | 4 | 16 |

The UPCI may be transmitted using TDM with the TPC commands, where the TDM is implemented within a slot. This may be achieved, for instance, by using a different F-DPCH slot format for the TPC command and for each of the UPCI fields that may be to be transmitted. Also, the same channelization code may be used to carry the TPC and UPCI thereby further simplifying implementation in the WTRU.

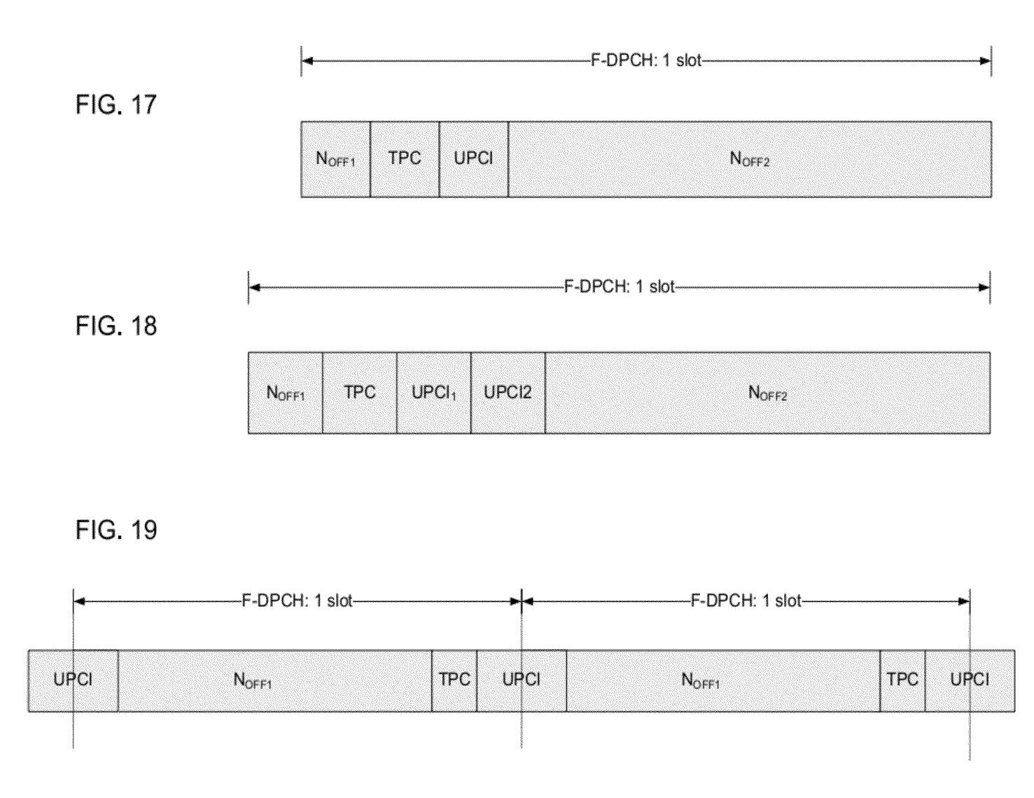

Referring to Table 14, the WTRU may be configured with F-DPCH slot format 0 for receiving the TPC command, and F-DPCH slot formats 1A for receiving UPCI. Thus, the WTRU receives the TPC and UPCI information in TDM within the same slot, as shown in FIG. 17.

The WTRU may be configured with F-DPCH slot format 0 for receiving the TPC command, and F-DPCH slot format 1A and 2A for receiving UPCI. Thus the WTRU receives the TPC and UPCI information in TDM within the same slot, as illustrated in FIG. 18. However, unlike the example shown in FIG. 17, more than one field is used to carry the UPCI. The WTRU may combine the individual partial UPCIs from both fields to form the final UPCI index.

When more than one two bits of UPCI are transmitted in the same slot, a new set of F-DPCH formats may be specified for the proper field's length. For example, when four bits of UPCI are used, a new format could be defined as shown in Table 15 below.

TABLE 15

| Slot | Channel | Channel | | | | | | |
|---|---|---|---|---|---|---|---|---|
| Format | Bit Rate | Symbol Rate | | | NOFF1 | NTPC | NUPCI | NOFF2 |
| #i | (kbps) | (ksps) | SF | Bits/Slot | Bits/Slot | Bits/Slot | Bits/Slot | Bits/Slot |
| 0 | 3 | 1.5 | 256 | 20 | 2 | 2 | 0 | 16 |
| 0A | 6 | 1.5 | 256 | 20 | 2 | 0 | 4 | 14 |
| 1 | 3 | 1.5 | 256 | 20 | 4 | 2 | 0 | 14 |
| 1A | 6 | 1.5 | 256 | 20 | 4 | 0 | 4 | 12 |
| 2 | 3 | 1.5 | 256 | 20 | 6 | 2 | 0 | 12 |
| 2A | 6 | 1.5 | 256 | 20 | 6 | 0 | 4 | 10 |
| 3 | 3 | 1.5 | 256 | 20 | 8 | 2 | 0 | 10 |
| 3A | 6 | 1.5 | 256 | 20 | 8 | 0 | 4 | 8 |
| 4 | 3 | 1.5 | 256 | 20 | 10 | 2 | 0 | 8 |
| 4A | 6 | 1.5 | 256 | 20 | 10 | 0 | 4 | 6 |
| 5 | 3 | 1.5 | 256 | 20 | 12 | 2 | 0 | 6 |
| 5A | 6 | 1.5 | 256 | 20 | 12 | 0 | 4 | 2 |
| 6 | 3 | 1.5 | 256 | 20 | 14 | 2 | 0 | 4 |
| 6A | 6 | 1.5 | 256 | 20 | 14 | 0 | 4 | 0 |
| 7 | 3 | 1.5 | 256 | 20 | 16 | 2 | 0 | 2 |
| 7A | 6 | 1.5 | 256 | 20 | 16 | 0 | 4 | 0 |
| 8 | 3 | 1.5 | 256 | 20 | 18 | 2 | 0 | 0 |
| 8A | 6 | 1.5 | 256 | 20 | 18 | 0 | 4* | 0 |
| 9 | 3 | 1.5 | 256 | 20 | 0 | 2 | 0 | 18 |
| 9A | 6 | 1.5 | 256 | 20 | 0 | 0 | 4 | 16 |

In Table 15, the slot format 8A is special in that the UPCI field would overlap the next slot (without being logically part of it). FIG. 19 shows an F-DPCH slot format with an UPCI overlapping an adjacent slot.

Optionally, the UPCI may not be transmitted every slot, in which case the WTRU may not monitor the fields associated to UPCI during the known DTX periods.

There are a number of methods that may be used to map the codeword information to a bit sequence to be signaled. The following methods may be used in any order or combination.

In a first method, the actual codeword information may be mapped to a specific bit sequence carried on the UPCI. In a second method, the codewords in the codebook are mapped to a specific bit sequence such as to protect large phase variations in case of signaling errors. For example, in the case of the F-DPCH with gray encoding, the codewords corresponding to bit combination 11, 00 would have larger precoder phase differences, just the same as the codewords corresponding to bit combinations 10, 01. Accordingly, the phase difference between codewords in the first group and second group may have a smaller difference than within each group. Thus, in one embodiment, precoder phases that differ by 180 degrees are paired and assigned codewords that have bit sequences that are opposites (logical inverses). An equivalent way to characterize the sequence pairs is that bit sequence pairs with the largest Hamming distances are used to represent precoder phase values that differ by 180 degrees. Table 16 shows one such example mapping having opposite bit sequences for precoder phase values having differences of 180 degrees. The example mapping of a phase codebook shows an example of possible phases between precoder weights. That is, the codeword phase represents the desired phase difference between the two precoder weights to be applied to the signals at a two antenna system. An intended codeword phase of zero degrees means the weights have identical phase values, whereas a codeword phase of 180 degrees means the precoding weights have phases that differ by 180 degrees.

TABLE 16

| Bit combination | Codeword Phase (Degrees) |
|---|---|
| 00 | 0 |
| 01 | 90 |
| 10 | 270 |
| 11 | 180 |

The signaling bits may be modulated using any appropriate constellation.

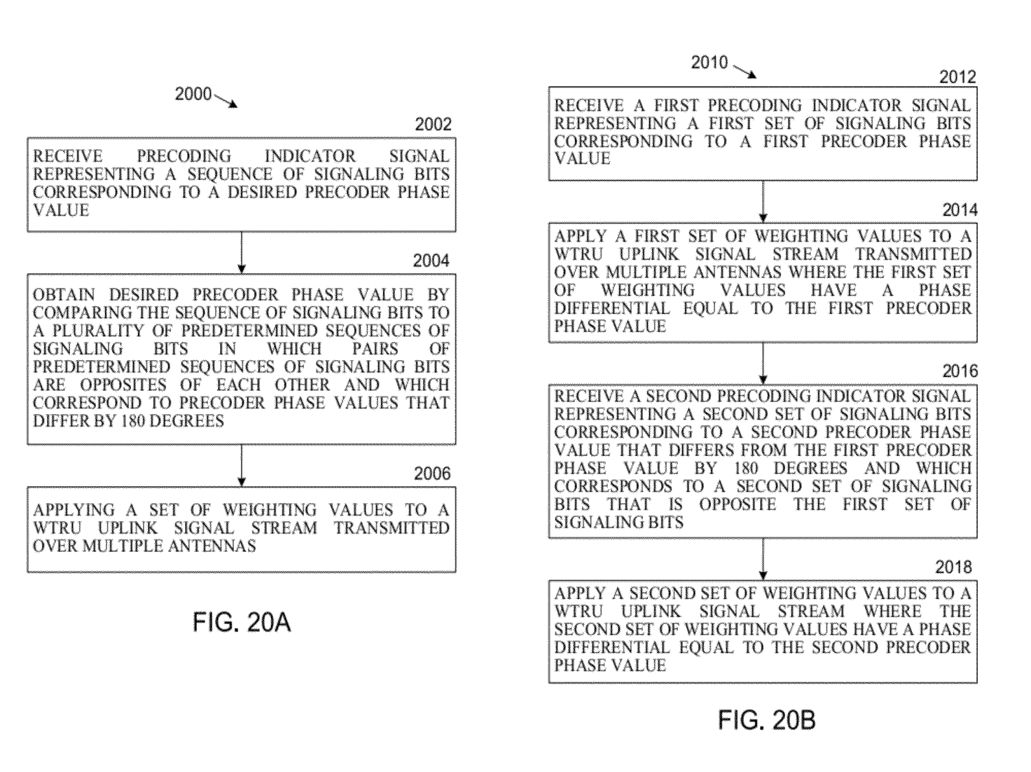

FIG. 20A is a block diagram of a one embodiment of a method 2000. At block 2002, a wireless transmit/receive unit (WTRU) receives a precoding indicator signal representing a sequence of signaling bits corresponding to a desired precoder phase value. At block 2004, the WTRU obtains the desired precoder phase value by comparing the sequence of signaling bits to a plurality of predetermined sequences of signaling bits. As described above, pairs of predetermined sequences of signaling bits are opposites of each other and are mapped so as to correspond to precoder phase values that differ by the largest increments, which is often set at 180 degrees. At block 2006, the WTRU applies a set of weighting values to its uplink signal stream transmitted over multiple antennas where the set of weighting values have a phase differential equal to the desired precoder phase value. The precoding indicator signal may be carried on a fractional channel of a wideband code-division multiple access downlink signal transmission. The sequence of signaling bits is equivalent to two information bits in length, which may be represented as two data bits if BPSK modulation is used, or four data bits if QPSK modulation is used. The precoding indicator signal is a modulated version of the sequence of signaling bits.

The pairs of predetermined sequences of signaling bits and the corresponding precoder phase values are in accordance with the following mapping:
sequence 00: phase 0 degrees;
sequence 11: phase 180 degrees;
sequence 01: phase 90 degrees;
sequence 10: phase 270 degrees.

The method 2010 shown in FIG. 20B depicts at block 2012, receiving at a wireless transmit/receive unit (WTRU) a first precoding indicator signal representing a first set of signaling bits corresponding to a first precoder phase value. At block 2014, a first set of weighting values is applied to a WTRU uplink signal stream transmitted over multiple antennas where the first set of weighting values have a phase differential equal to the first precoder phase value. At block 2016, a second precoding indicator signal is received representing a second set of signaling bits corresponding to a second precoder phase value that differs from the first precoder phase value by 180 degrees and which corresponds to a second set of signaling bits that is opposite the first set of signaling bits. At block 2018 the WTRU applies a second set of weighting values to a WTRU uplink signal stream where the second set of weighting values have a phase differential equal to the second precoder phase value.

The precoding indicator signal may be carried on a fractional channel of a wideband code-division multiple access downlink signal transmission, and in one embodiment the first set of signal bits and the second set of signaling bits, and the respective corresponding first and second precoder phase values are either:

sequence 00, phase 0 degrees, and sequence 11, phase 180 degrees; or sequence 01, phase 90 degrees and sequence 10, phase 270 degrees.

In one embodiment of a wireless transmit-receive apparatus, the WTRU comprises a receiver configured to receive a precoding indicator signal and to recover a corresponding sequence of signaling bits; a control channel processor configured to obtain a desired precoder phase value from the sequence of signaling bits by comparing the sequence of signaling bits to a plurality of predetermined sequences of signaling bits in which pairs of predetermined sequences of signaling bits are opposites of each other and which correspond to precoder phase values that differ by 180 degrees; and, a transmitter configured to apply a set of weighting values to an uplink signal stream for transmission over multiple antennas where the set of weighting values have a phase differential equal to the desired precoder phase value.

The apparatus may further comprise a memory device wherein the pairs of predetermined sequences of signaling bits and the corresponding precoder phase values are stored in accordance with the following mapping:
sequence 00: phase 0 degrees;
sequence 11: phase 180 degrees;
sequence 01: phase 90 degrees;
sequence 10: phase 270 degrees.

The control channel processor may be further configured to recover the precoding indicator signal from a fractional channel of a wideband code-division multiple access downlink signal transmission.

In another embodiment, a wireless base station apparatus comprises: a processor configured to determine a desired precoder phase representing a phase offset between precoding weights of a wireless transmit-receive unit; a control channel processor configured to convert the desired precoder phase to a sequence of signaling bits where the sequence of signaling bits is selected from a plurality of predetermined sequences of signaling bits in which pairs of predetermined sequences of signaling bits are opposites of each other and which correspond to precoder phase values that differ by 180 degrees; and, a transmitter configured to generate a precoding indicator signal in response to the sequence of signaling bits.

The base station may further comprise a memory device wherein the pairs of predetermined sequences of signaling bits and the corresponding precoder phase values are stored in accordance with the following mapping:
sequence 00: phase 0 degrees;
sequence 11: phase 180 degrees;
sequence 01: phase 90 degrees;
sequence 10: phase 270 degrees.

The control channel processor may be further configured to send the sequence of signaling bits over a fractional channel of a wideband code-division multiple access downlink signal.

The E-RGCH or E-HICH physical channel structure may be reused to carry the downlink signal information for uplink transmit diversity TXD/MIMO.

A F-PCICH is a F-DPCH-like channel that carries PCI information. In the following, for convenience, one PCI symbol corresponds to two PCI information bits indicating a particular codeword in the pre-coding codebook. Also, one F-PCICH resource corresponds to one QPSK symbol, i.e., every F-PCICH slot contains 10 F-PCICH resources.

For a PCI update rate of 3-slot (2 ms) (signaling interval) and a PCI codebook size of 4 (2 bits, or 1 QPSK symbol), the following methods may be used to transmit PCI information.

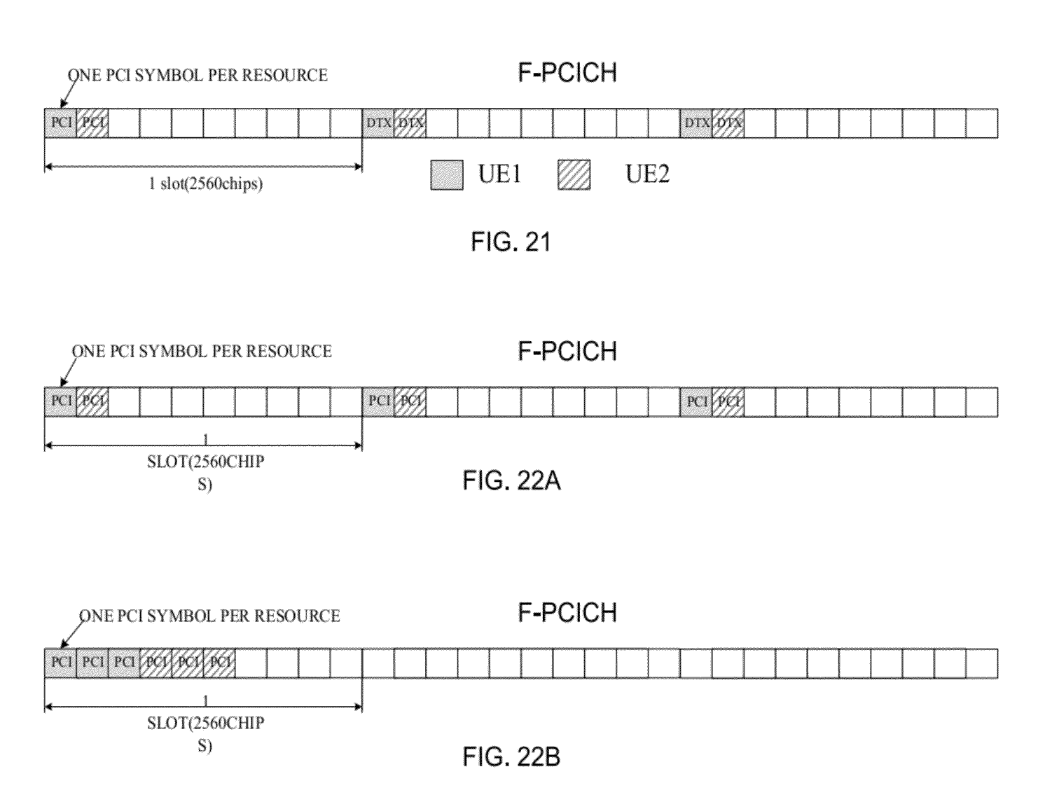

In a first method, one PCI symbol is transmitted per signaling interval that is, one F-PCICH resource, and DTX the F-PCICH resource in the other slots. For example, in the 3 slot signaling case, every 3 slots, the PCI symbol is transmitted only in one slot and the corresponding F-PCICH resources on the two other slots are DTXed (for that WTRU). FIG. 21 shows a method of transmitting one PCI symbol per signaling interval with DTX in a subframe (3 slots). This method may be advantageous because it uses a minimum amount of time and code-space resource. The DTX periods may be used by the Node B to signal PCI indication to other WTRUs.

In a second method, one PCI symbol is transmitted per F-PCICH resource with PCI symbol repetition over the signaling interval (here, N=3). FIG. 22A shows a method of transmitting a PCI symbol where the F-PCICH resources across 3 adjacent F-PCICH slots are used to transmit one PCI symbol. The second method may require less peak power than the first method to achieve the same level of reliability.

In a third method, one PCI symbol is transmitted per F-PCICH resource with PCI repetition this time over N (here, N=3) adjacent F-PCICH resources within the same F-PCICH slot. FIG. 22B shows a method of transmitting PCI where one PCI symbol is transmitted per F-PCICH resource with PCI repetitions. This method may require lower latency as all the signal energy is focused in a single slot interval.

Optionally, the reliability of downlink PCI transmission over the simple repetition schemes of FIG. 22A and FIG. 22B may be improved by applying constellation remapping to the transmitted symbols. This may be achieved by applying a different QPSK constellation for each transmission of the same PCI codeword over three F-PCICH resources. Accordingly, the constellation mapping may be designed such that the minimum Euclidean distance is 4a after three transmissions.

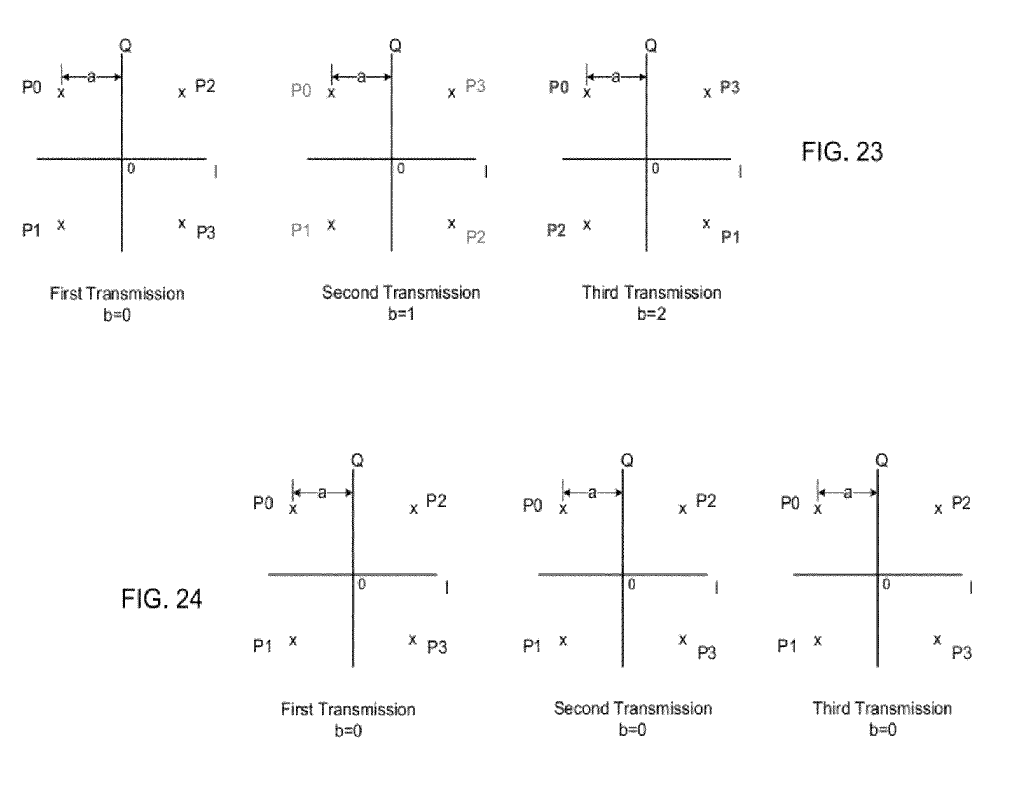

For the purpose of describing constellation remapping, four PCI codewords are labeled P0, P1, P2 and P3. An example mapping to bit sequence and QPSK symbols for these codewords is shown in Table 17. FIG. 23 shows one possible constellation mapping PCI transmission with QPSK constellation remapping. The parameter b in FIG. 23 represents the constellation version index and one potential set of rules of mapping of codewords P0, P1, P2 and P3 to QPSK symbols are shown in Table 18 for a=1. The constellation mappings shown in Table 19 meet the constellation mapping rule that the minimum Euclidean distance is 4a.

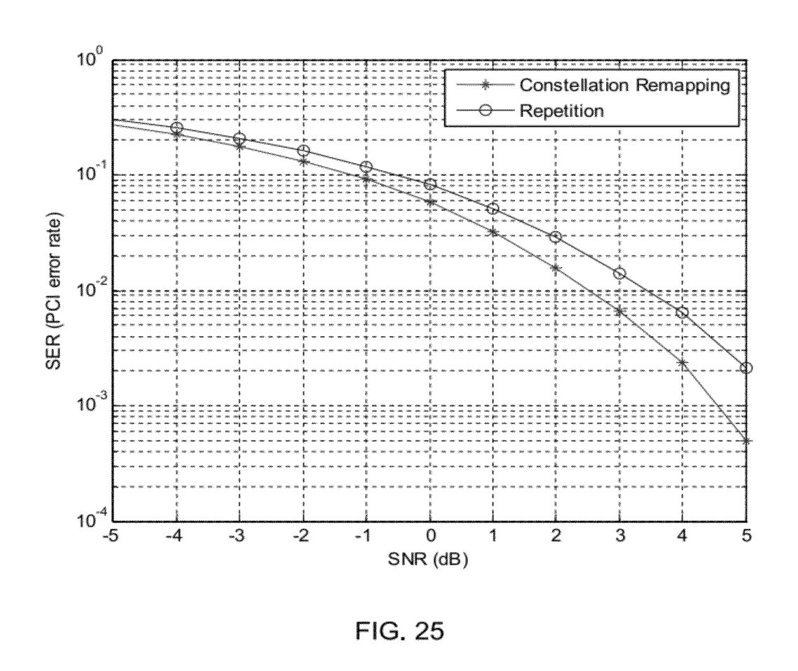

FIG. 24 shows one possible constellation mapping PCI transmission without constellation remapping. FIG. 25 shows a performance comparison in terms of the PCI error rate (or symbol error rate) where there is no remapping and where there is remapping. Approximately 1 dB gain is achieved at point of interest of PCI error rate of 10-2. This gain is due to the fact that after 3 transmissions the minimum Euclidean distance is increased from 2\sqrt{3}a with simple repetition to 4a with constellation remapping.

TABLE 17

| | | QPSK symbol |
|---|---|---|
| codeword | bits | (b = 0) |
| P0 | 00 | −1 + j |
| P1 | 01 | −1 − j |
| P2 | 10 | 1 + j |
| P3 | 11 | 1 − j |

TABLE 18

| Constellation | | | | |
|---|---|---|---|---|
| version | Mapping of codewords to QPSK symbols | | | |
| parameter b | P0 | P1 | P2 | P3 |
| 0 | −1 + j | −1 − j | 1 + j | 1 − j |
| 1 | −1 + j | −1 − j | 1 − j | 1 + j |
| 2 | −1 + j | 1 − j | −1 − j | 1 + j |

TABLE 19

| | Quadrant | | | | | | | | | | | |
|---|---|---|---|---|---|---|---|---|---|---|---|---|
| | −, + | | | +, + | | | +, − | | | −, − | | |
| Transmission | b = 0 | b = 1 | b = 2 | b = 0 | b = 1 | b = 2 | b = 0 | b = 1 | b=2 | b = 0 | b = 1 | b = 2 |
| Constellation 1 | P0 | P0 | P0 | P2 | P3 | P3 | P3 | P2 | P1 | P1 | P1 | P2 |
| Constellation 2 | P0 | P0 | P0 | P2 | P3 | P2 | P3 | P2 | P1 | P1 | P1 | P3 |
| Constellation 3 | P0 | P0 | P1 | P2 | P3 | P3 | P3 | P2 | P0 | P1 | P1 | P2 |
| Constellation 4 | P0 | P0 | P1 | P2 | P3 | P2 | P3 | P2 | P0 | P1 | P1 | P3 |
| Constellation 5 | P0 | P0 | P0 | P2 | P1 | P3 | P3 | P2 | P1 | P1 | P3 | P2 |
| Constellation 6 | P0 | P0 | P0 | P2 | P1 | P2 | P3 | P2 | P1 | P1 | P3 | P3 |
| Constellation 7 | P0 | P0 | P1 | P2 | P1 | P3 | P3 | P2 | P0 | P1 | P3 | P2 |
| Constellation 8 | P0 | P0 | P1 | P2 | P1 | P2 | P3 | P2 | P0 | P1 | P3 | P3 |
| Constellation 9 | P0 | P2 | P0 | P2 | P3 | P3 | P3 | P0 | P1 | P1 | P1 | P2 |
| Constellation 10 | P0 | P2 | P0 | P2 | P3 | P2 | P3 | P0 | P1 | P1 | P1 | P3 |
| Constellation 11 | P0 | P2 | P1 | P2 | P3 | P3 | P3 | P0 | P0 | P1 | P1 | P2 |
| Constellation 12 | P0 | P2 | P1 | P2 | P3 | P2 | P3 | P0 | P0 | P1 | P1 | P3 |
| Constellation 13 | P0 | P2 | P0 | P2 | P1 | P3 | P3 | P0 | P1 | P1 | P3 | P2 |
| Constellation 14 | P0 | P2 | P0 | P2 | P1 | P2 | P3 | P0 | P1 | P1 | P3 | P3 |
| Constellation 15 | P0 | P2 | P1 | P2 | P1 | P3 | P3 | P0 | P0 | P1 | P3 | P2 |
| Constellation 16 | P0 | P2 | P1 | P2 | P1 | P3 | P3 | P0 | P0 | P1 | P3 | P3 |

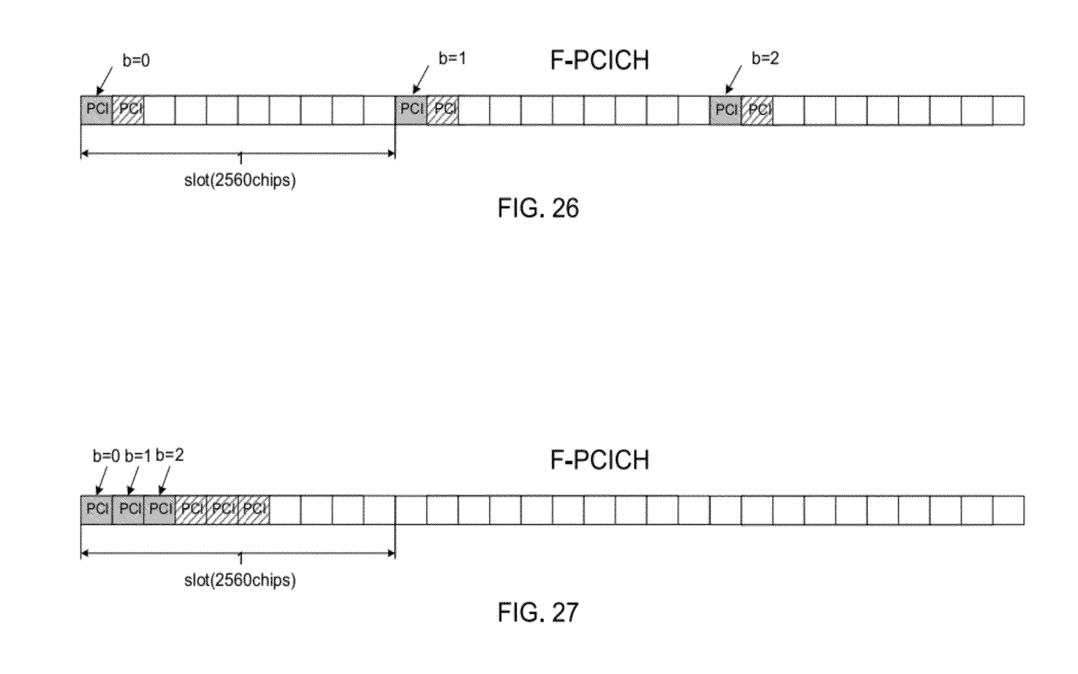

Accordingly, two improved methods of PCI transmission corresponding to repetition based methods shown in FIG. 21 and FIG. 22, are shown in FIG. 26 and FIG. 27, respectively.

FIG. 26 shows a PCI transmission across three different slots with constellation re-mapping. In a first method shown in FIG. 26, one PCI symbol per F-PCICH resource with PCI symbol repetition over the signaling interval (N=3 in this example) is transmitted. The constellation index changes for each transmission with periodic repetition. According to this method, the power of the signal is spread over three slots and is also minimized for the same signal reception quality by using the proposed constellation remapping.

FIG. 27 shows a PCI transmission within one slot with constellation re-mapping. In a second method shown in FIG. 27, one PCI symbol is transmitted per F-PCICH resource with PCI repetition over N (e.g. N=3) adjacent F-PCICH resources within the same F-PCICH slot, where the constellation index is changed every symbol with periodic repetition. As illustrated in FIG. 27, one PCI symbol here takes 3 F-PCICH resources. One advantage of this approach is that the latency associated to transmission of the PCI is reduced as only 1 slot is required for its transmission. Further, by applying the proposed constellation remapping approach, a smaller amount of power is required to achieve the same reliability.

To give a Node B the flexibility of the using the methods described above with simple repetition or the methods using constellation remapping, a new RRC message may be used to enable/disable WTRU using constellation remapping for PCI transmission on F-PCICH.

WTRUs may use methods to receive and decode PCI when constellation remapping is applied.

A WTRU may start to receive new PCI information with the first constellation version b=0 according to a defined timing. A WTRU will not decode the PCI information until the PCI information with all three different constellation versions is received at the WTRU. The WTRU will perform joint detection based on the received PCI information with the three different constellation versions. After the transmitted PCI is detected, a WTRU may apply the precoding weight indicated by the detected PCI.

Although serving different purposes, the E-RGCH and E-HICH may share the same channel structure based on a set of orthogonal signature sequences encoded into 40 bits in a slot where symbol a may take values of −1, 0, or +1 to represent ‘UP’, ‘DOWN’, ‘HOLD’ respectively for E-RACH, or values of +1 and −1 to represent ‘ACK’ and ‘NACK’ respectively for E-HICH, which may be expressed as:

bi,j=αCss,40,m(i),j, j=0,1, . . . ,39.

Depending on the slot index i, the signature hopping pattern m(i) may be determined by the Table 20 where the sequence index l is configured by the network.

TABLE 20

| Sequence | Row index m(i) for slot i | | |
|---|---|---|---|
| index 1 | i mod 3 = 0 | i mod 3 = 1 | i mod 3 = 2 |
| 0 | 0 | 2 | 13 |
| 1 | 1 | 18 | 18 |
| 2 | 2 | 8 | 33 |
| 3 | 3 | 16 | 32 |
| 4 | 4 | 13 | 10 |
| 5 | 5 | 3 | 25 |
| 6 | 6 | 12 | 16 |
| 7 | 7 | 6 | 1 |
| 8 | 8 | 19 | 39 |
| 9 | 9 | 34 | 14 |
| 10 | 10 | 4 | 5 |
| 11 | 11 | 17 | 34 |
| 12 | 12 | 29 | 30 |
| 13 | 13 | 11 | 23 |
| 14 | 14 | 24 | 22 |
| 15 | 15 | 28 | 21 |
| 16 | 16 | 35 | 19 |
| 17 | 17 | 21 | 36 |
| 18 | 18 | 37 | 2 |
| 19 | 19 | 23 | 11 |
| 20 | 20 | 39 | 9 |
| 21 | 21 | 22 | 3 |
| 22 | 22 | 9 | 15 |
| 23 | 23 | 36 | 20 |
| 24 | 24 | 0 | 26 |
| 25 | 25 | 5 | 24 |
| 26 | 26 | 7 | 8 |
| 27 | 27 | 27 | 17 |
| 28 | 28 | 32 | 29 |
| 29 | 29 | 15 | 38 |
| 30 | 30 | 30 | 12 |
| 31 | 31 | 26 | 7 |
| 32 | 32 | 20 | 37 |
| 33 | 33 | 1 | 35 |
| 34 | 34 | 14 | 0 |
| 35 | 35 | 33 | 31 |
| 36 | 36 | 25 | 28 |
| 37 | 37 | 10 | 27 |
| 38 | 38 | 31 | 4 |
| 39 | 39 | 38 | 6 |

Then for a 2 ms High-Speed Uplink Packet Access (HSUPA) configuration, the 1 bit information represented by symbol α may be transmitted over three consecutive time slots using different signature sequences according to the signature hopping pattern.

For sending more signaling bits for uplink TXD/MIMO, a slot-based symbol transmission may be used, i.e., the output bits in a slot may be transmitted by

b_{i,j}=α(i)C_{ss,40,m(i),j}, j=0,1, . . . ,39

Different symbols may be transmitted on each slot, which modifies the transmission rate to three bits/sub-frame.

These three bits over E-RGCH/E-HICH may be used to signal additional information to support the uplink MIMO operation, such as an index to a table that specifies the relative signal quality (e.g., MIMO rank information or ΔSIR) of the secondary stream with respect to the primary stream.

Or these three bits may be used to signal the precoding weight information provided by the network, which is capable of sending an index to eight sets of precoding weights to the WTRU.

If only four precoding weights are to be signaled, an encoding scheme of (3,2) rate may be introduced to improve the reliability of transmission. For example, Table 21 shows an example of (3,2) encoding.

TABLE 21

| | | | |
|---|---|---|---|
| CW1 | 0 | 0 | 0 |
| CW2 | 0 | 1 | 1 |
| CW3 | 1 | 0 | 1 |
| CW4 | 1 | 1 | 0 |

The above table has minimum coding distance of two (2) and is only exemplary. Other codebooks may be designed to have similar or better coding distance performance.

The same channelization code used by E-RGCH/E-HICH may be shared for the proposed signaling. But to distinguish from their original purposes, a different signature hopping pattern may be assigned by the network, i.e., a new sequence index l as defined in Table 20 may be configured by the network. Optionally, different channelization code may be applied which may start with a new physical channel.

Alternatively, to send more signaling bits for uplink TXD/MIMO, a quadrature phase-shift keying (QPSK) modulation may be applied on the E-RGCH/E-HICH symbol α. For example, α may take four complex values:

α={1+j,1−j,−1+j,−1−j}

As result, the E-RGCH/HICH capacity may be expanded to 4 bits/sub-frame, which allows a precoding codebook of four weights being signaled.

The first and second solutions may be applied in combination that may deliver a six bits/sub-frame E-RGCH/HICH data rate. These six bits may be used to serve all purposes simultaneously in the same sub-frame including providing signaling to indicate the relative serving grant the WTRU; providing signaling to indicate the precoding weights; and providing signaling to indicate the relative signal quality or MIMO rank information of the secondary stream.

For example, one bit may be allocated to item 1, 2 bits for item 2, and three bits for item 3.

With more bits being transmitted in the E-RGCH/E-HICH, more transmit power may be used to maintain a quality of service (QoS).

In a third solution, the E-RGCH/HICH frame structure is applied as is. The ‘UP’, ‘HOLD’, and ‘DOWN’ commands carried by E-RGCH may be used to step forward and backward among the entries of a precoding weight table with a pre-determined order. The differential codebook signaling may be executed by the signaling provided by E-RGCH.

Additionally, signaling may be provided for an incremental update of the relative signal quality (e.g., MIMO rank information or ΔSIR) of the secondary stream with respect to the primary stream. In particular, the ‘UP’, ‘HOLD’, and ‘DOWN’ commands carried by E-RGCH may be used to step up and down among the entries of a table representing the power or SIR difference, of the two MIMO streams. Optionally, the signal quality may be updated by directly modify with a fixed up/down step size according to the E-RGCH commands received.

Alternatively, orthogonal sequences may be used to signal precoding weight information by one-to-one mapping each sequence to a precoding weight in the codebook. These sequences may be a subset of E-RGCH and E-HICH signature sequences or a new set of sequences. Assuming a 4-codeword codebook is used, four signature sequences may be reserved to signal four codewords. One embodiment may signal multiple signature sequences (one more signature sequence for weight information other than signature sequences for the hybrid ARQ acknowledgement indicator and relative grant) given one E-HICH/E-GRCH channelization code, which may support multiple WTRUs, e.g., it may support up to six MIMO/CLTD WTRUs within one channelization code given 40 of total E-RGCH/E-HICH signature sequences. Alternatively, another E-RGCH/E-HICH channelization code is reserved and used for UPCI transmission, by which the legacy E-RGCH/E-HICH is intact at the cost of WTRU architecture and processing power, and may support up to ten MIMO/CLTD WTRUs by reusing 40 E-RGCH/E-HICH signature sequences.

DL signaling may also be carried by the Absolute Grant Channel (E-AGCH).

A separate E-RNTI may be assigned to the UL-MIMO capable WTRU. Then an E-RNTI-specific Cyclic Redundancy Check (CRC) may be attached to the E-AGCH message in order to differentiate from its conventional use. The six bits of information carried by the E-AGCH may be applied to indicate various signal conditions for uplink TXD/MIMO including: providing signaling to indicate serving grant for second stream; providing signaling to indicate the selected or preferred precoding weights; providing signaling to initialize the relative signal quality information of the secondary MIMO stream, and a dynamic update may be performed by the incremental means by E-RGCH.

In another embodiment, the absolute grant scope bit, x_{ags},1, may be redefined to have following specification specifically for the WTRUs configured with uplink MIMO.

Table 22 uses x_{ags},1 to indicate different use of E-AGCH.

TABLE 22

| x_{ags},1 | Purpose |
|---|---|
| 0 | Conventional use for absolute serving grant |
| | scope for “All HARQ processes” |
| 1 | Uplink TXD/MIMO related signaling |

In another embodiment, the same E-RNTI may be used for E-AGCH, but the E-AGCHs of different types may be sent using TDM at different sub-frames. For example, E-AGCH sent at even or odd numbered sub-frames may carry different signaling as shown in Table 23.

TABLE 23

| Sub-frame number | Purpose |
|---|---|
| Even | Conventional use for absolute serving |
| | grant |
| Odd | Uplink TXD/MIMO related signaling |

Or two E-AGCHs may be sent in consecutive sub-frames and the second one may be used for the additional signaling by uplink TXD/MIMO.

In another embodiment, two E-AGCHs may be sent simultaneously using code division multiplexing CDM by using two channelization codes.

DL signaling may also be performed via the HS-SCCH or a HS-SCCH order.

Weight information may be signaled via the HS-SCCH by a separate H-RNTI which is assigned to the UL-MIMO capable WTRU. For example, using a H-RNTI to implicitly indicate that the particular HS-SCCH is for UL MIMO control information. An H-RNTI-specific Cyclic Redundancy Check (CRC) is attached to the HS-SCCH message carrying MIMO/CLTD information in order to differentiate from its conventional use. The information carried by the HS-SCCH may be re-interpreted or applied to fulfill various signaling for uplink MIMO/CLTD including: providing signaling to indicate serving grant for second stream; providing signaling to indicate the selected or preferred precoding weights; and providing signaling to initialize the relative signal quality information of the secondary MIMO stream, and a dynamic update may be performed by the incremental means by E-RGCH.

Alternatively, weight information may be signaled by HS-SCCH orders.

For the E-DCH transmission on the next TTI, the Node-B may to signal to the WTRU two different types of absolute grant (AG) at the same time, including an AG for rank 2 transmission which includes AG for the primary stream and AG for the secondary stream, and AG for rank 1 transmission.

These two different types of absolute grants may be signaled in any one or a combination of the following ways.

AGs may be multiplexed for rank 2 transmission with AG for rank 1 transmission before attaching a E-RNTI specific CRC and channel coding, i.e., a single E-AGCH is generated for a WTRU.

Alternatively, AGs may be multiplexed for rank 2 transmission before attaching a E-RNTI specific CRC and channel coding and a E-AGCH channel may be generated for rank 2 transmission AGs. Then, a second E-AGCH may be generated carrying rank 1 transmission AG where an E-RNTI different from the E-RNTI used for rank 2 transmission is used.

Alternatively AGs for rank 2 transmission and AG for rank 1 transmission may be transmitted using time multiplexing with a pattern configured by upper layers. For example, Node B may send N rank-2 AG every period of M subframes and send rank-1 AG in remaining time.

In a cell where UL MIMO capable WTRUs and legacy/non UL MIMO capable WTRUs coexist, to minimize the impact to the legacy WTRU's E-HICH/E-RGCH channels, for MIMO capable WTRUs, the existing E-HICH/E-RGCH channel structure may be used to transmit the relative grant and/or ACK/NACK for the primary stream. For the secondary stream, a new or second E-RGCH/HICH channel may be constructed using a SF128 channelization code orthogonal with the one used by the legacy E-HICH/E-RGCH channel so that the 40-bit signature sequence may be reused.

When the WTRU is in soft handover (SHO), the weights used at the WTRU may be signaled to non-serving cells for data demodulation if the DPCCHs are not pre-coded. Also, other control information may be signaled to non-Serving cells for weight generation if non-serving cells also involve the selection of weights. So various signaling methods are described in greater detail hereafter for UL MIMO/CLTD when the WTRU is in SHO.

Weight information may be selected and signaled from the WTRU to the Node-B on the UL when the WTRU is in SHO.

If HS-DPCCH is decoded at the serving Node-B, the WTRU may select the weights by emphasizing on the serving Node-B if applying precoding to HS-DPCCH. One example may use two sets of precoding weights: one set of precoding weight selected for HS-DPCCH by emphasizing on the serving Node-B, and the other set of precoding weights selected for other pre-coded UL channels than HS-DPCCH which may or may not emphasize on the serving Node-B.

Reliability performance of the HS-DPCCH may affect the DL performance, in case PWI and/or AWI errors occur, the precoding weights may not be applied to the HS-DPCCH. A power offset may be added for the HS-DPCCH to compensate the transmit diversity gain whenever HS-DPCCH is not pre-coded and experiencing different propagation channel from other pre-coded channels.

Non-serving Node-Bs may be signaled with the weights and power offset of the second DPCCH used by the WTRU for data demodulation. The WTRU may signal power offset in a semi-static manner such as adding the weights and/or power offset of the second DPCCH into the MAC header; or optionally send those information by any of L1 signaling proposed for the case then the WTRU is not in SHO.

The UL power control signal may be generated by comparing the target SIR set by the RNC and measured SIR at the Node-B. The measured SIR may be based on an UL DPCCH pilot.

Alternatively, the effective channel state information may be applied (i.e. H_{eff}=H_{w}), which accounts for the antenna weights w, used at the WTRU, to measure the SIR. To determine the antenna weights used at the WTRU, the Node-B may apply the preferred weights generated by serving cell to the estimated SIR based on non-precoded DPCCH. This may assume the WTRU is using the preferred weights. Alternatively, the Node-B may receive and apply the weight information, e.g. UPCI carried on the UL control channel, which is determined by the WTRU. Or WTRU may generate and use AWI. Another alternative may comprise performing SIR estimation based on non-precoded DPCCH while the RNC compensates the target SIR determined by OLPC by a certain amount due to the transmit diversity gain.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method comprising:
receiving at a wireless transmit/receive unit (WTRU) a precoding indicator signal representing a sequence of signaling bits corresponding to a desired precoder phase value;
obtaining the desired precoder phase value by comparing the sequence of signaling bits to a plurality of predetermined sequences of signaling bits in which pairs of predetermined sequences of signaling bits are opposites of each other and which correspond to precoder phase values that differ by 180 degrees; and,
applying a set of weighting values to a WTRU uplink signal stream transmitted over multiple antennas where the set of weighting values have a phase differential equal to the desired precoder phase value.

2. The method of claim 1 wherein the precoding indicator signal is carried on a fractional channel of a wideband code-division multiple access downlink signal transmission.

3. The method of claim 1 wherein the sequence of signaling bits represents two information bits.

4. The method of claim 3 wherein the pairs of predetermined sequences of signaling bits and the corresponding precoder phase values are in accordance with the following mapping:
sequence 00: phase 0 degrees;
sequence 11: phase 180 degrees;
sequence 01: phase 90 degrees;
sequence 10: phase 270 degrees.

5. The method of claim 1 wherein the precoding indicator signal is a modulated version of the sequence of signaling bits.

6. A method comprising:
receiving at a wireless transmit/receive unit (WTRU) a first precoding indicator signal representing a first set of signaling bits corresponding to a first precoder phase value;
applying a first set of weighting values to a WTRU uplink signal stream transmitted over multiple antennas where the first set of weighting values have a phase differential equal to the first precoder phase value;
receiving at the WTRU a second precoding indicator signal representing a second set of signaling bits corresponding to a second precoder phase value that differs from the first precoder phase value by 180 degrees and which corresponds to a second set of signaling bits that is opposite the first set of signaling bits; and,
applying a second set of weighting values to a WTRU uplink signal stream where the second set of weighting values have a phase differential equal to the second precoder phase value.

7. The method of claim 6 wherein the precoding indicator signal is carried on a fractional channel of a wideband code-division multiple access downlink signal transmission.

8. The method of claim 6 wherein the first set of signal bits and the second set of signaling bits, and the respective corresponding first and second precoder phase values are either:
sequence 00, phase 0 degrees, and sequence 11, phase 180 degrees;
or
sequence 01, phase 90 degrees and sequence 10, phase 270 degrees.

9. A wireless transmit-receive apparatus comprising:
a receiver configured to receive a precoding indicator signal and to recover a corresponding sequence of signaling bits;
a control channel processor configured to obtain a desired precoder phase value from the sequence of signaling bits by comparing the sequence of signaling bits to a plurality of predetermined sequences of signaling bits in which pairs of predetermined sequences of signaling bits are opposites of each other and which correspond to precoder phase values that differ by 180 degrees; and,
a transmitter configured to apply a set of weighting values to an uplink signal stream for transmission over multiple antennas where the set of weighting values have a phase differential equal to the desired precoder phase value.

10. The apparatus of claim 9 further comprising a memory device wherein the pairs of predetermined sequences of signaling bits and the corresponding precoder phase values are stored in accordance with the following mapping:
sequence 00: phase 0 degrees;
sequence 11: phase 180 degrees;
sequence 01: phase 90 degrees;
sequence 10: phase 270 degrees.

11. The apparatus of claim 9 wherein the control channel processor is further configured to recover the precoding indicator signal from a fractional channel of a wideband code-division multiple access downlink signal transmission.

12. A wireless base station apparatus comprising:
a processor configured to determine a desired precoder phase representing a phase offset between precoding weights of a wireless transmit-receive unit;
a control channel processor configured to convert the desired precoder phase to a sequence of signaling bits where the sequence of signaling bits is selected from a plurality of predetermined sequences of signaling bits in which pairs of predetermined sequences of signaling bits are opposites of each other and which correspond to precoder phase values that differ by 180 degrees; and,
a transmitter configured to generate a precoding indicator signal in response to the sequence of signaling bits.

13. The apparatus of claim 12 further comprising a memory device wherein the pairs of predetermined sequences of signaling bits and the corresponding precoder phase values are stored in accordance with the following mapping:
sequence 00: phase 0 degrees;
sequence 11: phase 180 degrees;
sequence 01: phase 90 degrees;
sequence 10: phase 270 degrees.

14. The apparatus of claim 12 wherein the control channel processor is further configured to send the sequence of signaling bits over a fractional channel of a wideband code-division multiple access downlink signal.
